(19) United States
(12) Patent Application Publication
(10) Pub. No.: US 2019/0323672 A1
(43) Pub. Date: Oct. 24, 2019

(54) VEHICULAR LAMP FITTING

(71) Applicant: STANLEY ELECTRIC CO., LTD., Tokyo (JP)

(72) Inventors: Shota NISHIMURA, Tokyo (JP); Kazuma KAMIOKA, Tokyo (JP)

(21) Appl. No.: 16/390,932

(22) Filed: Apr. 22, 2019

(30) Foreign Application Priority Data
Apr. 23, 2018 (JP) 2018-082204
Apr. 24, 2018 (JP) 2018-082996

(51) Int. Cl. F21S 41/26

(52) U.S. Cl. CPC F21S 41/26; F21W 2102/16

(57) ABSTRACT

A vehicular lamp fitting comprising a front lens body, a rear lens unit, and a light source that emits light, which passes through the rear lens unit and the front lens body, to form a low beam light distribution pattern, wherein the rear lens unit is a lens unit configured to condense, in a first direction, the light coming from the light source, and includes a first entry surface, and a first exit surface, the front lens body is a lens unit configured to condense, in a second direction, the light coming from the rear lens unit, and includes a second entry surface, and a second exit surface, the front lens body is disposed in an attitude that is inclined, and a curvature of the first exit surface in the longitudinal section or a curvature of the second entry surface in the longitudinal section is different in each longitudinal section.

### CROSS-REFERENCE TO RELATED APPLICATIONS

This application is based upon and claims the benefit of priority of the prior Japanese Patent Application No. 2018-082204, filed on Apr. 23, 2018, and the Japanese Patent Application No. 2018-082996, filed on Apr. 24, 2018, the entire contents of which are incorporated herein by reference.

### FIELD

The present invention relates to a vehicular lamp fitting, and more particularly to a vehicular lamp fitting which suppresses generation of the relative drop of luminous intensity in a part of a predetermined light distribution pattern (e.g. low beam light distribution pattern) (generation of a blurred state), even if a front lens body is disposed in an attitude that is inclined at a predetermined receding angle.

### BACKGROUND

FIG. 15 is a longitudinal sectional view of a conventional vehicular lamp fitting 100. FIG. 16 is a lateral sectional view of the vehicular lamp fitting 100 illustrated in FIG. 15 (portions other than the major optical surface are omitted).

Conventionally a vehicular lamp fitting 100 is known, which includes: a front lens body 101; a rear lens unit 102 disposed behind the front lens body 101; and a light source 103 that is disposed behind the rear lens unit 102, and that emits light, which passes through the rear lens unit 102 and the front lens body 101 in this order, and is irradiated forward, so as to form a predetermined light distribution pattern (e.g. low beam light distribution pattern), as illustrated in FIG. 15 (e.g. see WO 2015/178155 (FIG. 32)). The rear lens unit 102 is a lens unit configured to condense light in a first direction (e.g. direction orthogonal to the paper surface in FIG. 15), and the front lens body 101 is a lens unit configured to condense light in a second direction orthogonal to the first direction (e.g. vertical direction in FIG. 15).

The rear lens unit 102 includes a first entry surface 102a, a first exit surface 102b disposed on the opposite side of the first entry surface 102a, an edge 102c disposed between the first entry surface 102a and the first exit surface 102b (disposed on a focal point F), and a reflection surface 102d which extends backward from the edge 102c. A curvature of the first exit surface 102b in the longitudinal section is the same in each longitudinal section.

The front lens body 101 includes a second entry surface 101a and a second exit surface 101b disposed on the opposite side of the second entry surface 101a.

The front lens body 101 and the rear lens unit 102 are connected by a connecting unit 104. The connecting unit 104 connects an upper part of the front lens body 101 and an upper part of the rear lens unit 102 in a state of forming a space Sa between the front lens body 101 and the rear lens unit 102.

The front lens body 101, the rear lens unit 102 and the connecting unit 104 are integrally molded by injecting such transparent resin as polycarbonate and acrylic into a die.

In concrete terms, the front lens body 101, the rear lens unit 102 and the connecting unit 104 are formed by a die of which extracting direction is the opposite from the connecting unit 104 (see the arrow mark AR in FIG. 15). To smoothly extract the die, the second entry surface 101a of the front lens body 101 is formed as a plane.

The second exit surface 101b of the front lens body 101, on the other hand, is configured as a semicircular cylindrical surface (cylindrical surface), of which cylindrical axis extends in a first direction (linearly), in order to condense the light coming from the light source 103, which exits through the second exit surface 101b, in a second direction orthogonal to the first direction.

In the vehicular lamp fitting 100 having the above mentioned configuration, when the light source 103 is turned ON, the light coming from the light source 103 enters the rear lens unit 102 through the first entry surface 102a, is partially shielded by a reflection surface 102d, and exits through the first exit surface 102b, together with the reflected light coming from the reflection surface 102d. At this time, the light coming from the light source 103, which exits through the first exit surface 102b, is condensed in the first direction by a function of the first exit surface 102b. Then the light coming from the light source 103, which exited through the first exit surface 102b, passes through the space Sa between the rear lens unit 102 and the front lens body 101, further enters the front lens body 101 through the second entry surface 101a, exits through the second exit surface 101b, and is irradiated forward. At this time, the light coming from the light source 103, which exits through the second exit surface 101b, is condensed in the second direction by a function of the second exit surface 101b. Thereby the predetermined light distribution pattern (the low beam light distribution pattern in this case) is formed.

### PRIOR ART

[Patent Document 1] WO 2015/178155

### SUMMARY

However, after intensive studies, the present inventors discovered that in the case of the vehicular lamp fitting 100 having the above mentioned configuration, a relative drop of luminous intensity in a part of the predetermined light distribution pattern (the low beam light distribution pattern in this case) is generated (a blurred state is generated) when the front lens body 101 is disposed in an attitude that is included at a receding angle θ1 with respect to a reference axis AX1 extending in the vehicle width direction when viewed from the top, as illustrated in FIG. 16.

With the foregoing in view, it is a first object of the present invention to provide a vehicular lamp fitting which suppresses the generation of a relative drop of the luminous intensity in a part of a predetermined light distribution pattern (e.g. low beam light distribution pattern) (a generation of a blurred instate), even if the front lens body is disposed in an attitude that is inclined at a predetermined receding angle.

FIG. 24 is a longitudinal sectional view of a conventional vehicular lamp fitting 100. FIG. 25 is an example of disposing a plurality of light sources 103a to 103c in the vicinity of a focal point F of a projection lens constituted of a front lens body 101A and a rear lens unit 102A. FIG. 26 is a front view of the front lens body 101A illustrated in FIG. 25.

Conventionally a vehicular lamp fitting 100 is known, which includes: a front lens body 101; a rear lens unit 102 disposed behind the front lens body 101; and a light source 103 that is disposed behind the rear lens unit 102, and that emits light, which passes through the rear lens unit 102 and the front lens body 101 in this order and is irradiated forward, so as to form a low beam light distribution pattern, as illustrated in FIG. 24 (e.g. see WO 2015/178155 (FIG. 32)). The rear lens unit 102 is a lens unit configured to condense light in a first direction (e.g. direction orthogonal to the paper surface in FIG. 24), and the front lens body 101 is a lens unit configured to condense light in a second direction orthogonal to the first direction (e.g. vertical direction in FIG. 24).

The present inventors studied a forming of an ADB light distribution pattern by disposing a plurality of light sources 103a to 103c in the horizontal direction (direction orthogonal to the paper surface in FIG. 9), for example, in the vicinity of the focal point F of a projection lens constituted by the front lens body 101A and the rear lens unit 102A, as illustrated in FIG. 25, for example.

In order to enhance the design, the present inventors also studied disposing the front lens body 101A in an attitude that is inclined, with respect to the reference axis AX1 extending in the vehicle width direction, at an upward angle θ2 when viewed from the front, as illustrated in FIG. 26.

As a result of these studies, the present inventors discovered that in the case of disposing the front lens body 101A in an attitude that is inclined by the upward angle θ2, the ADB light distribution pattern is formed in a state of being diagonally deformed (diagonal blur state).

With the foregoing in view, it is a second object of the present invention to provide a vehicular lamp fitting which suppresses the generation of an ADB light distribution pattern in a state of being diagonally deformed (diagonal blur state), even if the front lens body is disposed in an attitude that is inclined at a predetermined upward angle.

In order to achieve the first object described above, an aspect of the present invention provides a vehicular lamp fitting comprising: a front lens body; a rear lens unit disposed behind the front lens body; and a light source that is disposed behind the rear lens unit, and that emits light, which passes through the rear lens unit and the front lens body in this order and is irradiated forward, so as to form a low beam light distribution pattern, wherein the rear lens unit is a lens unit configured to condense, at least in a first direction, the light coming from the light source and passing through the rear lens unit, and includes: a first entry surface through which the light coming from the light source enters the rear lens unit; a first exit surface through which the light coming from the light source, which entered the rear lens unit, exits; and an edge which defines a cut-off line of the low beam light distribution pattern, the front lens body is a lens unit configured to condense, in a second direction intersecting the first direction, the light coming from the rear lens unit and passing through the front lens body, and includes: a second entry surface through which the light coming from the rear lens unit enters the front lens body; and a second exit surface through which the light coming from the rear lens unit, which entered the front lens body, exits, the front lens body is disposed in an attitude that is inclined at a predetermined receding angle, and at least one of a curvature of the first exit surface in the longitudinal section and a curvature of the second entry surface in the longitudinal section is different in each longitudinal section.

According to this aspect, a vehicular lamp fitting which suppresses the generation of a relative drop of the luminous intensity in a part of the low beam light distribution pattern, is provided, even if the front lens body is disposed in an attitude that is inclined at a predetermined receding angle.

This is because at least one of a curvature of the first exit surface in the longitudinal section and a curvature of the second entry surface in the longitudinal section is different in each longitudinal section.

In addition, in a preferred aspect of the invention described above, the longitudinal section is a cross-section of the first exit surface or a cross-section of the second entry surface through which a horizontal ray group, which is included in each of a plurality of vertical surfaces having mutually different inclination angles, passes when the horizontal ray group, which is included in each of the plurality of vertical surfaces, enters the front lens body through the second exit surface, and

the edge is disposed along a focal line which is formed by condensation of the horizontal ray group, which is included in each of the plurality of vertical surfaces, in the rear lens unit when the horizontal ray group exits through the second entry surface and enters the rear lens unit through the first exit surface.

In addition, in a preferred aspect of the invention described above, at least one of the curvature of the first exit surface in the longitudinal section and the curvature of the second entry surface in the longitudinal section is adjusted for each longitudinal section so that the focal line becomes a focal line extending in the vehicle width direction.

In addition, in a preferred aspect of the invention described above, the curvature of the first exit surface in the longitudinal section is adjusted for each longitudinal section so as to be larger as the distance between the second entry surface and the first exit surface, through which the horizontal ray group included in each of the plurality of vertical surfaces passes, is shorter.

In addition, in a preferred aspect of the invention described above, the curvature of the second entry surface in the longitudinal section is adjusted for each longitudinal section so as to be larger as the distance between the second entry surface and the first exit surface through which the horizontal ray group included in each of the plurality of vertical surfaces passes, is shorter.

Another aspect of the present invention provides a vehicular lamp fitting comprising: a front lens body; a rear lens unit disposed behind the front lens body; and a light source that is disposed behind the rear lens unit, and that emits light, which passes through the rear lens unit and the front lens body in this order and is irradiated forward, so as to form a low beam light distribution pattern, wherein the rear lens unit is a lens unit configured to condense, at least in a first direction, the light coming from the light source and passing through the rear lens unit, and includes: a first entry surface through which the light coming from the light source enters the rear lens unit; a first exit surface through which the light coming from the light source, which entered the rear lens unit, exits; and an edge which defines a cut-off line of the low beam light distribution pattern, the front lens body is a lens unit configured to condense, in a second direction intersecting the first direction, the light coming from the rear lens unit and passing through the front lens body, and includes: a second entry surface through which the light coming from the rear lens unit enters the front lens body; and a second exit surface through which the light coming from the rear lens unit, which entered the front lens body, exits, the front lens body is disposed in an attitude that is inclined at a predetermined receding angle, the surface shape of at least one of the first exit surface and the second entry surface is adjusted so that when a horizontal ray group, which is included in each of a plurality of vertical surfaces having mutually different inclination angles, enters the rear lens unit through the front lens body from the front side of the front lens body, the horizontal ray group is condensed in the rear lens unit so as to form a focal line extending in the vehicle width direction, and the edge is disposed along the focal line.

Another aspect of the present invention provides a vehicular lamp fitting comprising: a front lens body; a rear lens unit disposed behind the front lens body; and a plurality of light sources that are disposed behind the rear lens unit, and that emit light, which passes through the rear lens unit and the front lens body in this order and is irradiated forward so as to form an ADB light distribution pattern, wherein the rear lens unit is a lens unit configured to condense, at least in a first direction, the light coming from the light sources and passing through the rear lens unit, and includes: a first entry surface through which the light coming from the light sources enters the rear lens unit; and a first exit surface through which the light coming from the light sources, which entered the rear lens unit, exits, the front lens body is a lens unit configured to condense, in a second direction intersecting the first direction, the light coming from the rear lens unit and passing through the front lens body, and includes: a second entry surface through which the light coming from the rear lens unit enters the front lens body; and a second exit surface through which the light coming from the rear lens unit, which entered the front lens body, exits, the front lens body is disposed in an attitude that is inclined at a predetermined receding angle, and at least one of a curvature of the first exit surface in the longitudinal section, a curvature of the first entry surface in the longitudinal section, and a curvature of the second entry surface in the longitudinal section is different in each longitudinal section.

According to this aspect, a vehicular lamp fitting which suppresses the generation of a relative drop of the luminous intensity in a part of the low beam light distribution pattern, is provided, even if the front lens body is disposed in an attitude that is inclined at a predetermined receding angle.

This is because at least one of a curvature of the first exit surface in the longitudinal section, a curvature of the first entry surface in the longitudinal section, and a curvature of the second entry surface in the longitudinal section is different in each longitudinal section.

In addition, in a preferred aspect of the invention described above, the longitudinal section is a cross-section of the first exit surface, or a cross-section of the first entry surface or the second entry surface through which a horizontal ray group, which is included in each of the plurality of vertical surfaces having mutually different inclination angles, passes when the horizontal ray group, which is included in each of the vertical surfaces, enters the front lens body through the second exit surface, and

the plurality of light sources are disposed along a focal line which is formed by condensation of the horizontal ray group, which is included in each of the plurality of vertical surfaces, behind the rear lens unit when the horizontal ray group passes through the front lens body and the rear lens unit.

In addition, in a preferred aspect of the invention described above, at least one of the curvature of the first exit surface in the longitudinal section, the curvature of the first entry surface in the longitudinal section, and the curvature of the second entry surface in the longitudinal section is adjusted for each longitudinal section so that the focal line becomes a focal line extending in the vehicle width direction.

In addition, in a preferred aspect of the invention described above, the curvature of the first exit surface in the longitudinal section is adjusted for each longitudinal section so as to be larger as the distance between the second entry surface and the first exit surface, through which the horizontal ray group included in each of the plurality of vertical surfaces passes, is shorter.

In addition, in a preferred aspect of the invention described above, the curvature of the first entry surface in the longitudinal section is adjusted for each longitudinal section so as to be larger as the distance between the second entry surface and the first exit surface through which the horizontal ray group included in each of the plurality of vertical surfaces passes, is shorter.

In addition, in a preferred aspect of the invention described above, the curvature of the second entry surface in the longitudinal section is adjusted for each longitudinal section so as to be larger as the distance between the second entry surface and the first exit surface through which the horizontal ray group included in each of the plurality of vertical surfaces passes, is shorter.

Another aspect of the present invention provides A vehicular lamp fitting comprising: a front lens body; a rear lens unit disposed behind the front lens body; and a plurality of light sources that are disposed behind the rear lens unit, and that emit light, which passes through the rear lens unit and the front lens body in this order and is irradiated forward, so as to form an ADB light distribution pattern, wherein the rear lens unit is a lens unit configured to condense, at least in a first direction, the light coming from the light sources and passing through the rear lens unit, and includes: a first entry surface through which the light coming from the light sources enters the rear lens unit; and a first exit surface through which the light coming from the light sources, which entered the rear lens unit, exits, the front lens body is a lens unit configured to condense, in a second direction intersecting the first direction, the light coming from the rear lens unit and passing through the front lens body, and includes: a second entry surface through which the light coming from the rear lens unit enters the front lens body; and a second exit surface through which the light coming from the rear lens unit, which entered the front lens body, exits, the front lens body is disposed in an attitude that is inclined at a predetermined receding angle, and the surface shape of at least one of the first exit surface, the first entry surface and the second entry surface is adjusted so that when a horizontal ray group, which is included in each of a plurality of vertical surfaces having mutually different inclination angles, enters the rear lens unit through the front lens body from the front side of the front lens body, the horizontal ray group is condensed behind the rear lens unit so as to form a focal line extending in the vehicle width direction, and the plurality of light sources are disposed along the focal line.

In order to achieve the second object described above, an aspect of the present invention provides a vehicular lamp fitting comprising: a front lens body; a rear lens unit disposed behind the front lens body; and a plurality of light sources that are disposed behind the rear lens unit, and that emit light, which passes through the rear lens unit and the front lens body in this order and is irradiated forward, so as to form an ADB light distribution pattern, wherein the rear lens unit is a lens unit configured to condense, at least in a first direction, the light coming from the light sources and passing through the rear lens unit, and includes: a first entry surface through which the light coming from the light sources enters the rear lens unit; and a first exit surface through which the light coming from the light sources, which entered the rear lens unit, exits, the front lens body is a lens unit configured to condense, in a second direction intersecting the first direction, the light coming from the rear lens unit and passing through the front lens body, and includes: a second entry surface through which the light coming from the rear lens unit enters the front lens body; and a second exit surface through which the light coming from the rear lens unit, which entered the front lens body, exits, the front lens body is disposed in an attitude that is inclined at a predetermined upward angle, a surface shape of at least one of the first exit surface, the first entry surface, and the second entry surface is adjusted so that a focal line of a projection lens constituted by the front lens body and the rear lens unit is a focal line extending in the horizontal direction, and the plurality of light sources are disposed along the focal line.

According to this aspect, a vehicular lamp fitting, which suppresses the generation of the ADB light distribution pattern in the state of being diagonally deformed (diagonal blur state), can be provided, even if the front lens body is disposed in an attitude that is inclined at a predetermined upward angle.

This is because a surface shape of at least one of the first exit surface, the first entry surface, and the second entry surface is adjusted so that the focal line of the projection lens formed by the front lens body and the rear lens unit becomes a focal line extending in the horizontal direction.

In addition, in a preferred aspect of the invention described above, the longitudinal section of the first entry surface includes:

a first longitudinal section including a first curve which has a first vertex, a first partial curve which extends linearly from the first vertex diagonally upward in the backward direction, and a second partial curve which extends linearly from the first vertex diagonally downward in the backward direction; and

a second longitudinal section including a first curve which has a second vertex, an inflection point, a third partial curve which extends upward from the inflection point and is convex in the forward direction, and a fourth partial curve which extends downward from the inflection point and is convex in the backward direction,

the first entry surface is a curved surface configured such that the surface shape gradually changes in a direction from the first curve to the second curve, and includes: a convex portion which extends linearly between the first vertex and the inflection point, and is convex in the forward direction; an upper surface which is disposed on the upper side of the linearly extending convex portion; and a lower surface which is disposed on the lower side of the convex portion, and

the convex portion extends linearly in a direction which is inclined with respect to the reference axis at a predetermined angle in the opposite direction of the predetermined upward angle when viewed from the back.

In addition, in a preferred aspect of the invention described above, the upper surface is a curved surface configured such that the surface shape gradually changes in a direction from the first partial curve to the third partial curve, and

the lower surface is a curved surface configured such that the surface shape gradually changes in a direction from the second partial curve to the fourth partial curve.

### BRIEF DESCRIPTION OF DRAWINGS

FIG. 1 is a top view of the vehicular lamp fitting 10;

FIG. 2 is a front view of the vehicular lamp fitting 10;

FIG. 3 is an A-A cross-sectional view of the vehicular lamp fitting 10 illustrated in FIG. 1;

FIG. 4 is a lateral sectional view of the vehicular lamp fitting 10 (portions other than the major optical surface are omitted);

FIG. 5A is an example of the low beam light distribution pattern which is formed when a curvature of the first exit surface 31b in the longitudinal section is the same in each longitudinal section, FIG. 5B is an example of the low beam light distribution pattern which is formed when the curvature of the first exit surface 31b in the longitudinal section is adjusted for each longitudinal section;

FIG. 6 is a lateral sectional view of the vehicular lamp fitting 10 (portions other than the major optical surface are omitted);

FIG. 7A indicates A2-A2 cross-section (longitudinal section) in FIG. 6, FIG. 7B indicates B2-B2 cross-section (longitudinal section) in FIG. 6, and FIG. 7C indicates C2-C2 cross-section (longitudinal section) in FIG. 6;

FIG. 8A is the A2-A2 cross-section (longitudinal section) in FIG. 6, FIG. 8B is the B2-B2 cross-section (longitudinal section) in FIG. 6, and FIG. 8C is the C2-C2 cross-section (longitudinal section) in FIG. 6;

FIG. 9A indicates the A1-A1 cross-section (longitudinal section) in FIG. 4, FIG. 9B indicates the B1-B1 cross-section (longitudinal section) in FIG. 4, and FIG. 9C indicates the C1-C1 cross-section (longitudinal section) in FIG. 4;

FIG. 10A indicates the A1-A1 cross-section (longitudinal section) in FIG. 4, FIG. 10B is the B1-B1 cross-section (longitudinal section) in FIG. 4, and FIG. 10C is the C1-C1 cross-section (longitudinal section) in FIG. 4;

FIG. 11 is a top view of the vehicular lamp fitting 10A (portions other than the major optical surface are omitted);

FIG. 12A is a B3-B3 sectional view of the vehicular lamp fitting 10A illustrated in FIG. 11 (portions other than the major optical surface are omitted), and FIG. 12B is a front view of a substrate K2;

FIG. 13 is an example of the ADB light distribution pattern which is formed when a curvature of the first exit surface 41b in the longitudinal section is the same in each longitudinal section;

FIG. 14 is a lateral sectional view of the vehicular lamp fitting 10A (portions other than the major optical surface are omitted);

FIG. 15 is a longitudinal sectional view of a conventional vehicular lamp fitting 100; and

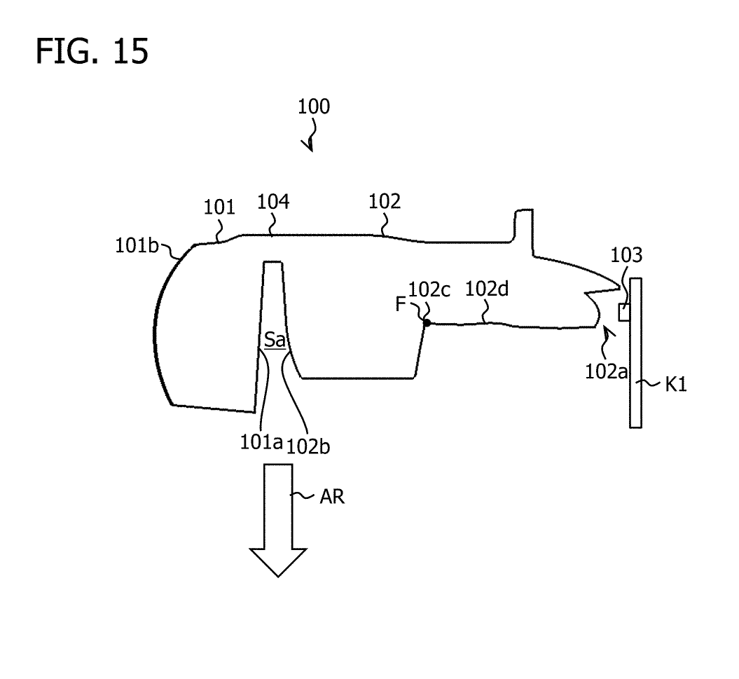

FIG. 16 is a lateral sectional view of the vehicular lamp fitting 100 illustrated in FIG. 15 (portions other than the major optical surface are omitted).

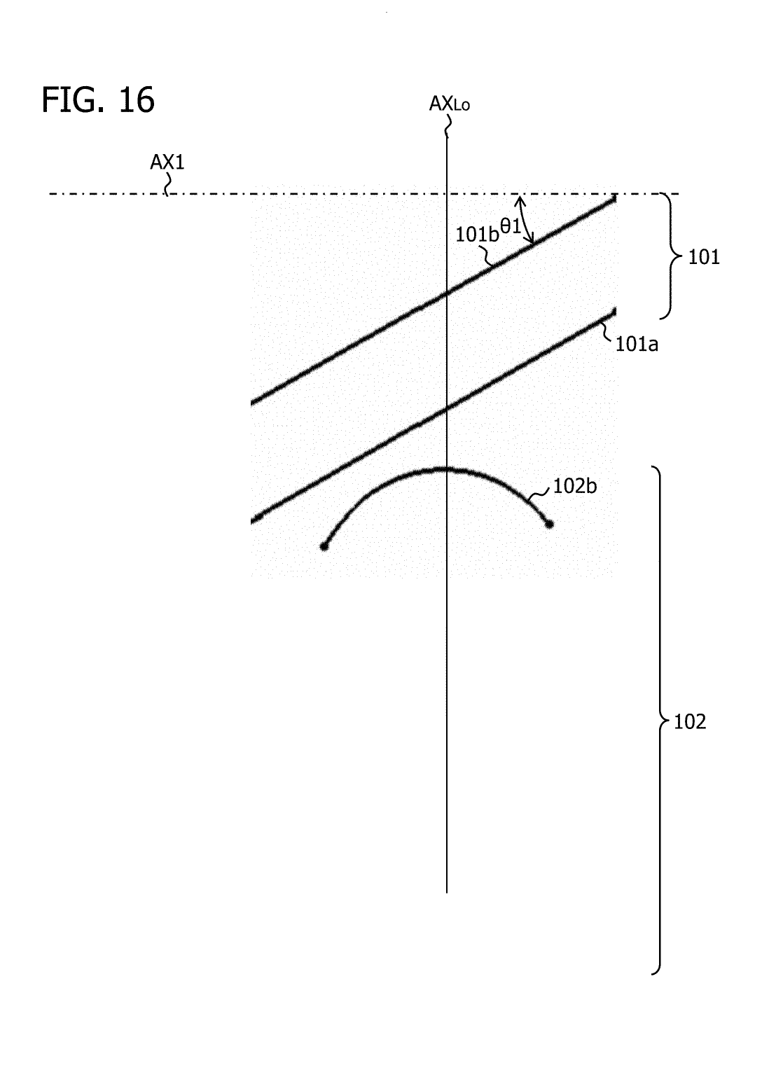

FIG. 17 is a top view of the vehicular lamp fitting 10B (portions other than the major optical surface are omitted);

FIG. 18 is a front view of the vehicular lamp fitting 10B;

FIG. 19A is an B-B cross-sectional view of the vehicular lamp fitting 10B illustrated in FIG. 17, and FIG. 19B is a front view of the substrate K2;

FIG. 20A indicates an example of the ADB light distribution pattern that is formed when the front lens body 20 is disposed in an attitude that is inclined at a predetermined upward angle θ2, and FIG. 20B is an example of the ADB light distribution pattern which is formed when the front lens body 20 is disposed in an attitude that is not inclined by the upward angle θ2.

FIG. 21 is a front view of the vehicular lamp fitting 10B (when the front lens body 20 is disposed in an attitude that is not inclined by the upward angle θ2);

FIG. 22 is a front view of the vehicular lamp fitting 10B;

FIG. 23A is a rear view of the rear lens unit 41 (front view of the first entry surface 41a), FIG. 23B is a D-D sectional view of the first entry surface 41a in FIG. 7A, and FIG. 23C is an E-E sectional view of the first entry surface 41a in FIG. 23A;

FIG. 24 is a longitudinal sectional view of a conventional vehicular lamp fitting 100;

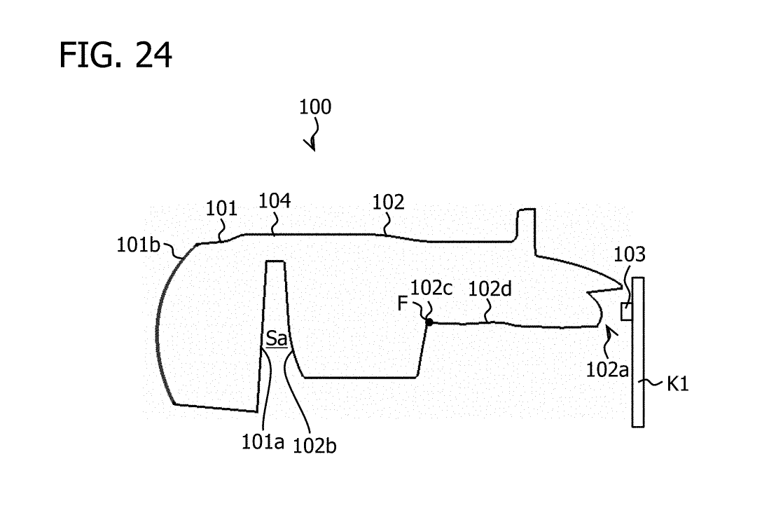

FIG. 25 is an example of disposing a plurality of light sources 103a to 103c in the vicinity of a focal point F of a projection lens constituted of a front lens body 101A and a rear lens unit 102A; and

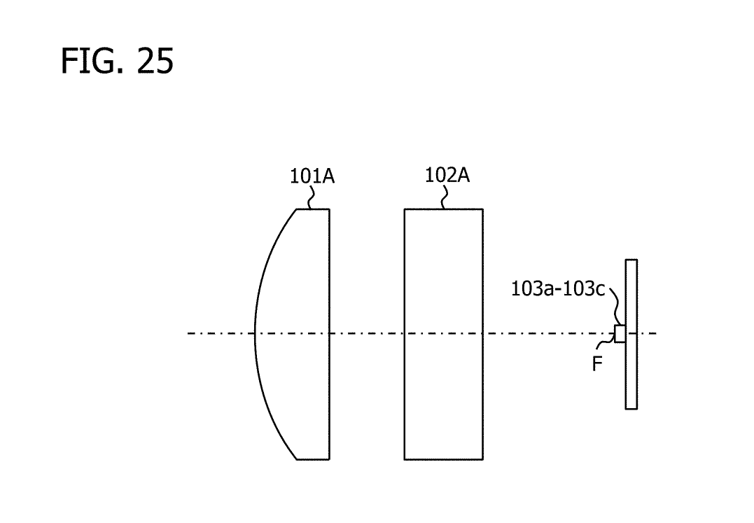

FIG. 26 is a front view of the front lens body 101A illustrated in FIG. 25.

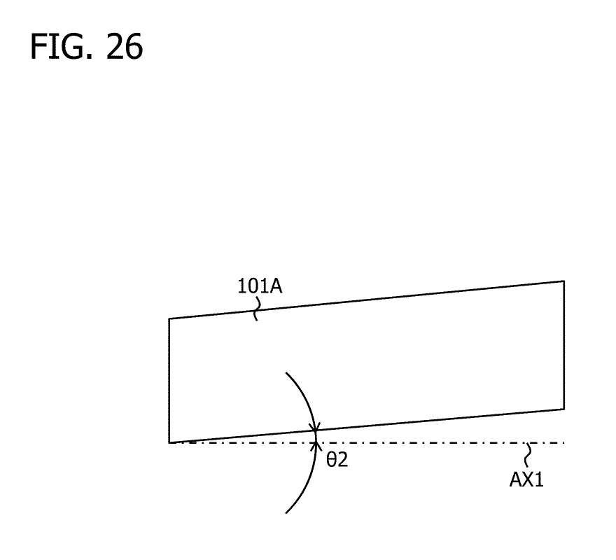

### DESCRIPTION OF EMBODIMENTS

### Embodiment 1

A vehicular lamp fitting 10 according to Embodiment 1 of the present invention will be described below with reference to the attached drawings. In each drawing, a corresponding composing element is denoted with a same reference symbol, and redundant description thereof will be omitted.

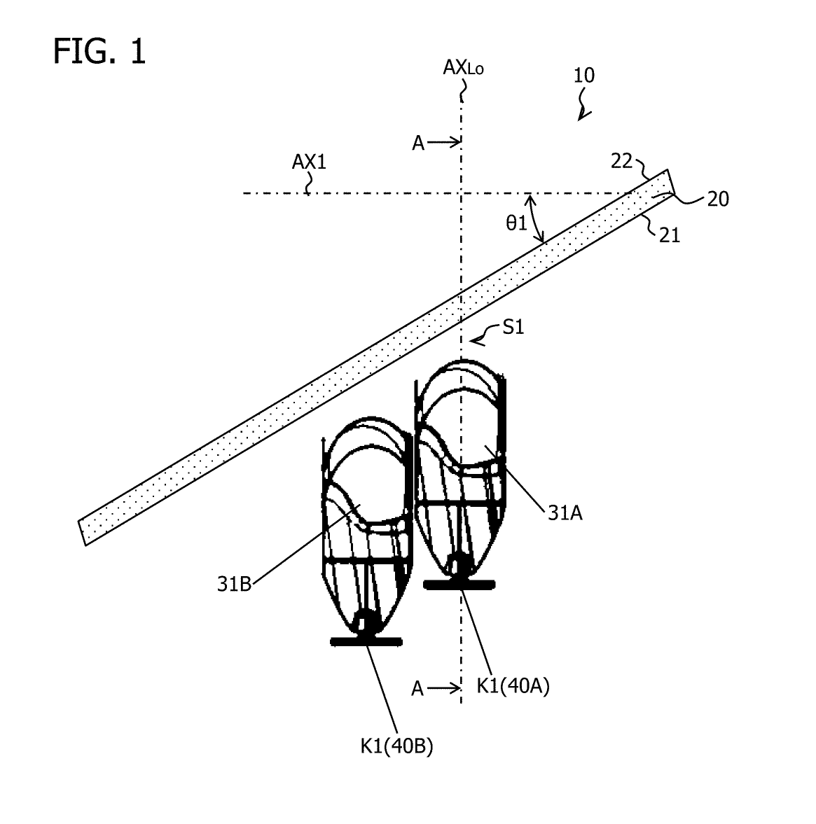

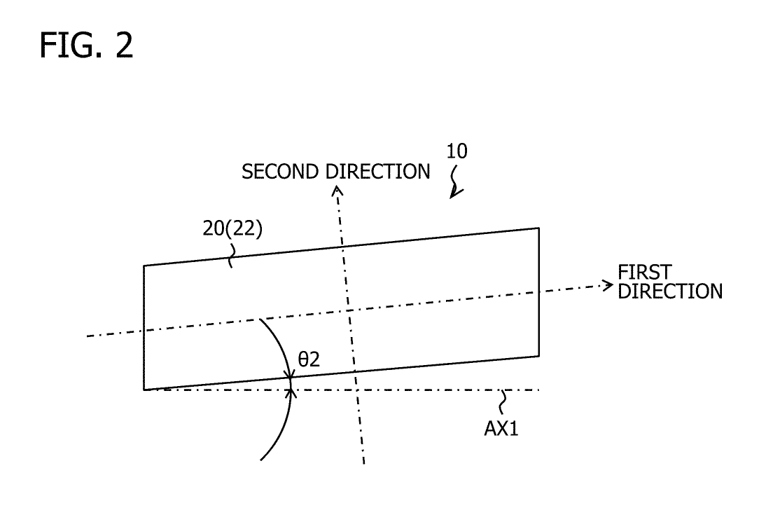

FIG. 1 is a top view of the vehicular lamp fitting 10. FIG. 2 is a front view of the vehicular lamp fitting 10.

The vehicular lamp fitting 10 shown in FIGS. 1 to 2 is a vehicular headlamp (headlamp) that can form a low beam light distribution pattern and is mounted to, for example, the left and right sides on the front end of a vehicle such as an automobile. Because the vehicular lamp fitting 10 to be mounted to both the left and right sides has a symmetrical configuration, a vehicular lamp fitting 10 mounted to the left side at the front of a vehicle (left side facing the front of the vehicle) is described as a representative example of the vehicular lamp fitting 10. Although not illustrated, the vehicular lamp fitting 10 is arranged in a lamp chamber constituted by an outer lens and a housing and is attached to the housing or the like.

As illustrated in FIG. 1 and FIG. 2, the vehicular lamp fitting 10 includes: a front lens body 20; a plurality of rear lens units 31A and 31B disposed behind the front lens body 20; and a plurality of light sources 40A and 40B, that are disposed behind the plurality of rear lens units 31A and 31B, and that emit respective light which passes through the rear lens units 31A and 31B and the front lens body 20 in this order, and is irradiated forward, so as to form a low beam light distribution pattern. The rear lens units 31A and 31B have the same configuration, and the light sources 40A and 40B have the same configuration. The rear lens units 31A and 31B are collectively referred to as “rear lens units 31” in the following description if the rear lens units 31A and 31B do not need to be distinguished from each other. Likewise, the light sources 40A and 40B are collectively referred to as “light sources 40” in the following description if the light sources 40A and 40B do not need to be distinguished from each other. A number of rear lens units 31 and a number of light sources 40 may be one respectively.

The front lens body 20 and the rear lens unit 31 are made of transparent resin such as acrylic and polycarbonate. The front lens body 20 and the rear lens unit 31 are separately molded in a physically separated state by injection molding. The front lens body 20 and the rear lens unit 31 are configured as a lens body connected by a holding member (not shown) such as a lens holder.

The front lens body 20 is a lens unit extending in a predetermined direction (also referred to as a first direction herein). The first direction is, for example, a direction inclined, with respect to a reference axis AX1 which extends in the vehicle width direction, at a receding angle θ1 when viewed from the top, as illustrated in FIG. 1, and also is a direction inclined, with respect to the reference axis AX1, at a upward angle θ2 when viewed from the front, as illustrated in FIG. 2. The angle θ1 is any angle that is greater than 0 and less than 90°. The angles θ2 is any angles from between 0° to 90°. To simplify description, an example where θ1 is 30° and θ2 is 0° will be described.

In a general vehicular lamp fitting, one projection lens is responsible for condensing light in the first direction and light in the second direction orthogonal to the first direction. In contrast, in this embodiment, two lenses (the front lens body 20 and the rear lens unit 31) which make up a projection lens are responsible for condensing light in the first direction and light in the second direction orthogonal to the first direction. More specifically, in this embodiment, the rear lens unit 31 is mainly responsible for condensing light in the first direction and the front lens body 20 is mainly responsible for condensing light in the second direction.

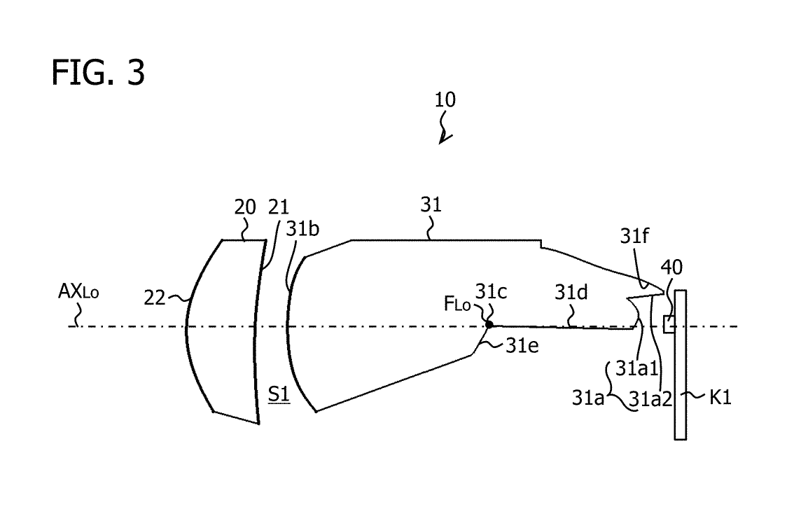

FIG. 3 is an A-A cross-sectional view of the vehicular lamp fitting 10 illustrated in FIG. 1. In FIG. 1, FIG. 3 and the like, the dotted line extending in the vehicle length direction, indicated by the reference symbol AX_{Lo}, is an optical axis of a projection lens which is configured by the front lens body 20 and the rear lens unit 31. This optical axis is hereafter referred to as the optical axis AX_{Lo}.

As illustrated in FIG. 3, the front lens body 20 includes a second entry surface 21 and a second exit surface 22 disposed on the opposite side of the second entry surface 21. The second entry surface 21 and the second exit surface 22 extend in the first direction (e.g. direction orthogonal to the paper surface in FIG. 3) respectively.

In concrete terms, as illustrated in FIG. 3, the second entry surface 21 is configured as a cylindrical surface that is convex in the forward direction and of which cylindrical axis extends in the first direction. The second exit surface 22 is configured as a cylindrical surface that is convex in the forward direction and of which cylindrical axis extends in the first direction. The curvature (curvature of a cross-section orthogonal to the first direction) of the second entry surface 21 is the same in each cross-section. The curvature (curvature of a cross-section orthogonal to the first direction) of the second exit surface 22 is the same in each cross-section. The second entry surface 21 and the second exit surface 22 may be a plane or a planar surface.

The light source 40 is a semiconductor light emitting element such as an LED or LD having a rectangular (for example, a 1 mm²) light emitting surface and is mounted to a substrate K1 with the light emitting surface facing forward (to the front). The substrate K1 is mounted to the housing (not shown) using a screw or another means.

The rear lens unit 31 includes a first entry surface 31a, a first exit surface 31b on the side opposite to the first entry surface 31a, an edge portion 31c provided (at a focal point F_{Lo}) between the first entry surface 31a and the first exit surface 31b, a reflection surface 31d extending toward the rear from the edge portion 31c, an extension surface 31e extending downward from the edge portion 31c, and a peripheral reflection surface 31f.

The first entry surface 31a includes: a central entry surface 31a1 which is convex toward the light source 40; and a tubular-shaped peripheral entry surface 31a2, which extends backward from (all or a part of) a peripheral edge of the central entry surface 31a1, and surrounds a space between the central entry surface 31a1 and the light source 40.

The central entry surface 31a1 is a surface through which light in a narrow angle direction with respect to the optical axis AX_{Lo} (which matches with the optical axis of the light source 40), out of the light coming from the light source 40, enters the rear lens unit 31. The central entry surface 31a1 is configured as a surface to condense the light coming from the light source 40, which enters the rear lens unit 31 through the central entry surface 31a1, in the vicinity of a focal point F_{Lo} (edge 31c), for example. In reality, the light source 40 is not a point light source but has a certain size, therefore the light coming from the light source 40, which enters the rear lens unit 31 through the central entry surface 31a1, is not perfectly condensed to one point (focal point F_{Lo}) but is condensed in the vicinity of the focal point F_{Lo} (edge 31c).

The focal point F_{Lo} is a condensed point on the optical axis AX_{Lo} in the rear lens unit 31, when horizontal rays, which are parallel with the optical axis AX_{Lo}, enter the rear lens unit 31 through the front lens body 20 from the front side of the front lens body 20.

The peripheral entry surface 31a2 is a surface through which light in a wide angel direction with respect to the optical axis AX_{Lo}, out of the light from the light coming from the light source 40, enters the rear lens unit 31. The light coming from the light source 40, which enters the rear lens unit 31 through the peripheral entry surface 31a2, is internally reflected (total reflection) by a peripheral reflection surface 31f.

The peripheral reflection surface 31f is configured as a surface to condense the light coming from the light source 40, which enters the rear lens unit 31 through the peripheral entry surface 31a2 and is internally reflected (total reflection) by the peripheral reflection surface 31f, in the vicinity of the focal point F_{Lo} (edge 31c). In reality, the light source 40 is not a point light source but has a certain size, therefore the light coming from the light source 40, which enters the rear lens unit 31 through the peripheral entry surface 31a2, is not perfectly condensed to one point (focal point F_{Lo}) but is condensed in the vicinity of the focal point F_{Lo} (edge 31c).

The first exit surface 31b is a surface through which the light coming from the light source 40, which entered the rear lens unit 31 through the first entry surface 31a, exits.

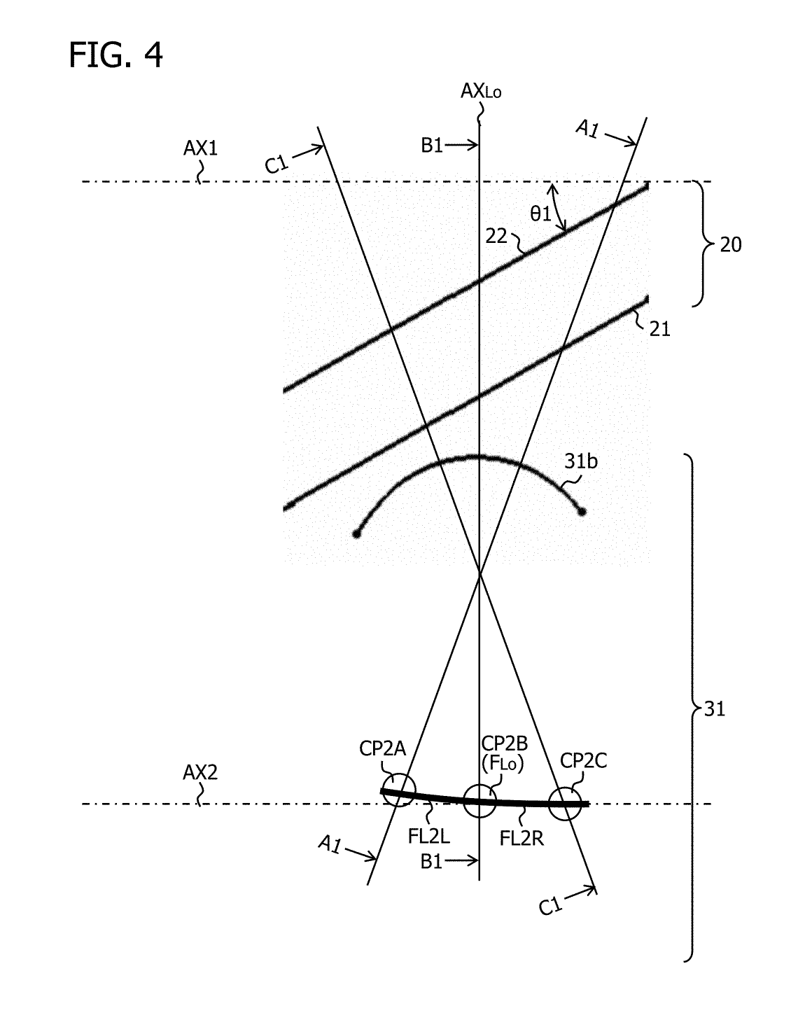

FIG. 4 is a lateral sectional view of the vehicular lamp fitting 10 (portions other than the major optical surface are omitted).

As illustrated in FIG. 4, the first exit surface 31b is configured as a curved surface that is convex in the forward direction in the lateral section. The curvature of the first exit surface 31b is the same in each lateral section. On the other hand, the curvature of the first exit surface 31b is not the same in each longitudinal section, but is different in each longitudinal section. For example, the curvature of the first exit surface 31b in the longitudinal section is different in the A1-A1 cross-section, B1-B1 cross section, and C1-C1 cross section respectively in FIG. 4. The B1-B1 cross-section is a longitudinal sectional which includes the optical axis AX_{Lo}. The A1-A1 cross-section is a cross-section which intersects with the optical axis AX_{Lo} inside the rear lens unit 31 at a point ahead of the later mentioned condensed point CP2B. The A1-A1 cross section is a longitudinal cross section inclined in the same direction as the front lens body 20 with respect to the optical axis AX_{Lo}. The C1-C1 cross-section is a cross-section which intersects with the optical axis AX_{Lo} inside the rear lens unit 31 at a point ahead of the later mentioned condensed point CP2B. The C1-C1 cross section is a longitudinal cross section inclined in the opposite direction as the front lens body 20 with respect to the optical axis AX_{Lo}. The A1-A1 cross-section, the B1-B1 cross-section and the C1-C1 cross-section all intersect at a same position inside the rear lens 31. In other words, the A1-A1 cross-section and the C1-C1 cross-section are vertical sections of which intersections with respect to the optical axis AX_{Lo} are at the same position, but inclination angles are different. It will be described later how the curvature of the longitudinal cross section of the first exit surface 31b differs in each longitudinal cross section.

The edge 31c is disposed along the focal line, as mentioned later. The edge 31c has a Z-shaped step difference (not illustrated), for example.

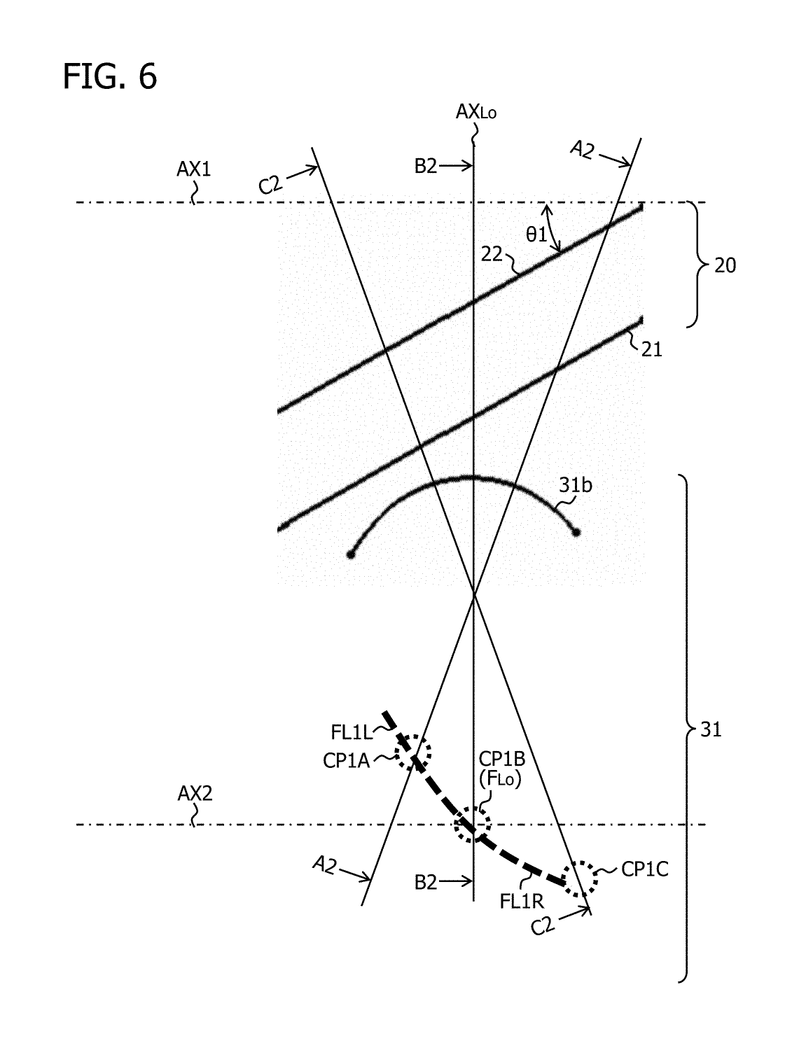

The focal line is a group of condensed points which are formed in the rear lens unit 31, when a plurality of horizontal rays, which are included in a plurality of vertical surfaces having mutually different inclination angles with respect to the optical axis AX_{Lo} respectively, enter the rear lens unit 31 through the front lens body 20 from the front side of the front lens body 20. The solid lines indicated by the reference symbols FL2L and FL2R in FIG. 4 and the dotted lines indicated by the reference symbols FL1L and FL1R in FIG. 6 are examples of the focal line. These lines are hereafter referred to as the focal line FL1L, focal line FL1R, focal line FL2L and focal line FL2R. The focal lines FL1L, FL1R, FL2L and FL2R will be described in detail later.

In the vehicular lamp fitting 10 having the above-described configuration, when the light sources 40 is turned on, the light from the light sources 40 enters the rear lens units 31 from the first entry surface 31a and condenses in the vicinity of the focal point F_{Lo} (edge 31c). Then, the light is partially blocked (shaded) by the reflection surface 31d and exits from the first exit surface 31b together with light reflected off the reflection surface 31d. At this time, the first exit surface 31b (lateral section of the first exit surface 31b) acts to condense, in the first direction, the light from the light source 40 which exits the first exit surface 31b. Then, the light from the light source 40 which has exited the first exit surface 31b passes through a space S1 between the rear lens unit 31 and the front lens body 20, further enters the front lens body 20 from the second entry surface 21 and is irradiated forward after exiting the second exit surface 22. At this time, the second exit surface 22 acts to condense, in the second direction, the light from the light source 40 which exits the second exit surface 22. Thereby, the low beam light distribution pattern is formed. The low beam light distribution pattern includes a cut-off line defined by the edge 31c at the upper end edge.

In other words, the light intensity distribution is formed in the vicinity of the edge 31c by the light from the light source 40 that has entered the rear lens unit 31. The rear lens unit 31 and the front lens body 20 (which are functioning as a projection lens) project the light intensity distribution forward. Thereby, a low beam light distribution pattern is formed.

A low beam light distribution pattern which is formed when a curvature of the first exit surface 31b in the longitudinal section is the same in each longitudinal section will be described next.

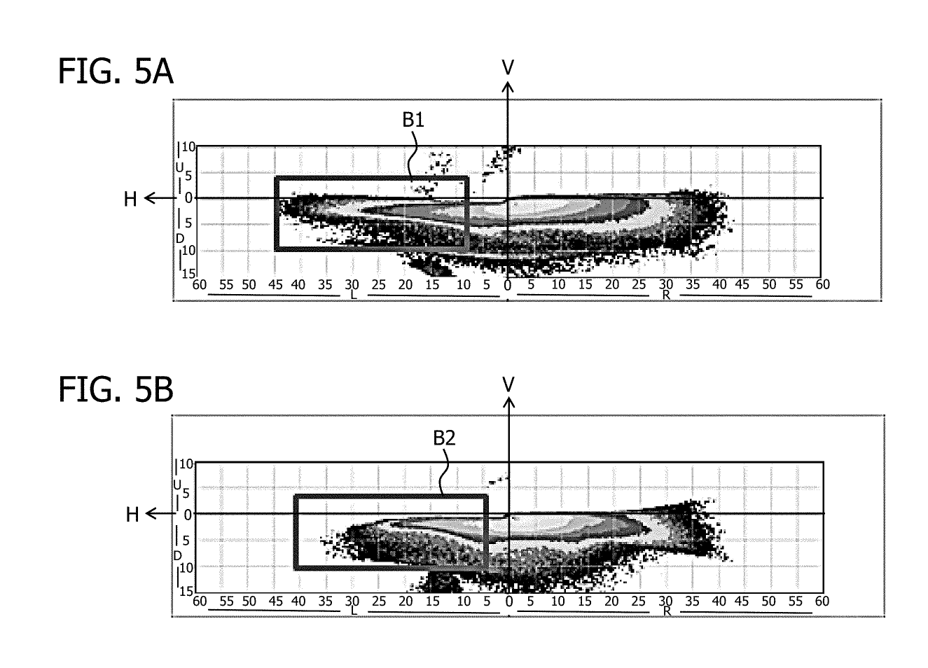

FIG. 5A is an example of the low beam light distribution pattern which is formed when a curvature of the first exit surface 31b in the longitudinal section is the same in each longitudinal section. FIG. 5A indicates an example of the low beam light distribution pattern which is formed on a virtual vertical screen facing the front surface of the vehicle (disposed at 25 m in the forward direction from the front surface of the vehicle).

The present inventors performed simulation and confirmed that a relative drop of the luminous intensity in a part of the low beam light distribution pattern is generated (a blurred state is generated) when the front lens body 20 is disposed in an attitude that is inclined with respect to the reference axis AX1 at a receding angle θ1, when viewed from the top, if the curvature of the first exit surface 31b in the longitudinal section is the same in each longitudinal section, as illustrated in FIG. 1.

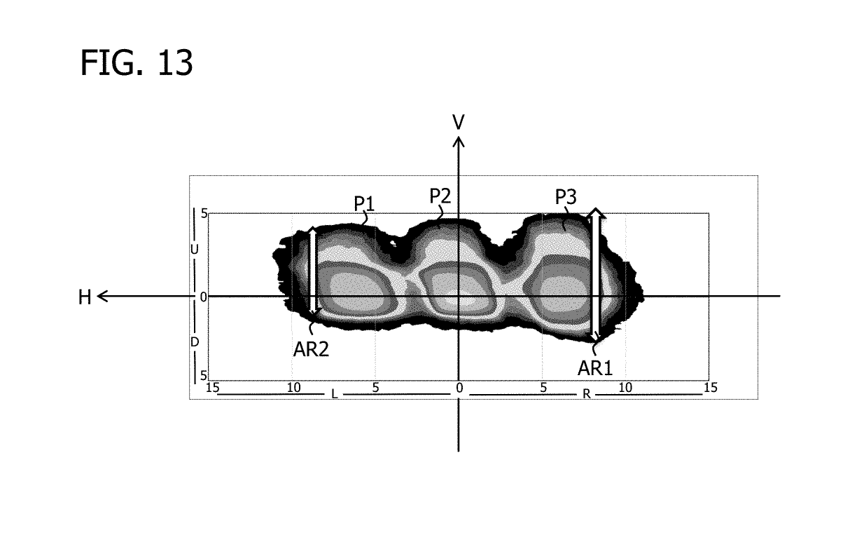

According to FIG. 5A, the luminous intensity around the cut-off area at 5 to 20° to the left is lower than the luminous intensity around the cut-off area at 5 to 20° to the right, for example, and a relative drop of the luminous intensity is generated in a part of the low beam light distribution pattern (a range enclosed by square B1 in FIG. 5A). In FIG. 5A and FIG. 5B, one square (each grid) indicates 5° longitudinally (vertical V direction) and 5° laterally (horizontal H direction). This is the same in FIG. 13. The reason for the drop of the luminous intensity in a part of the low beam light distribution pattern will be described below.

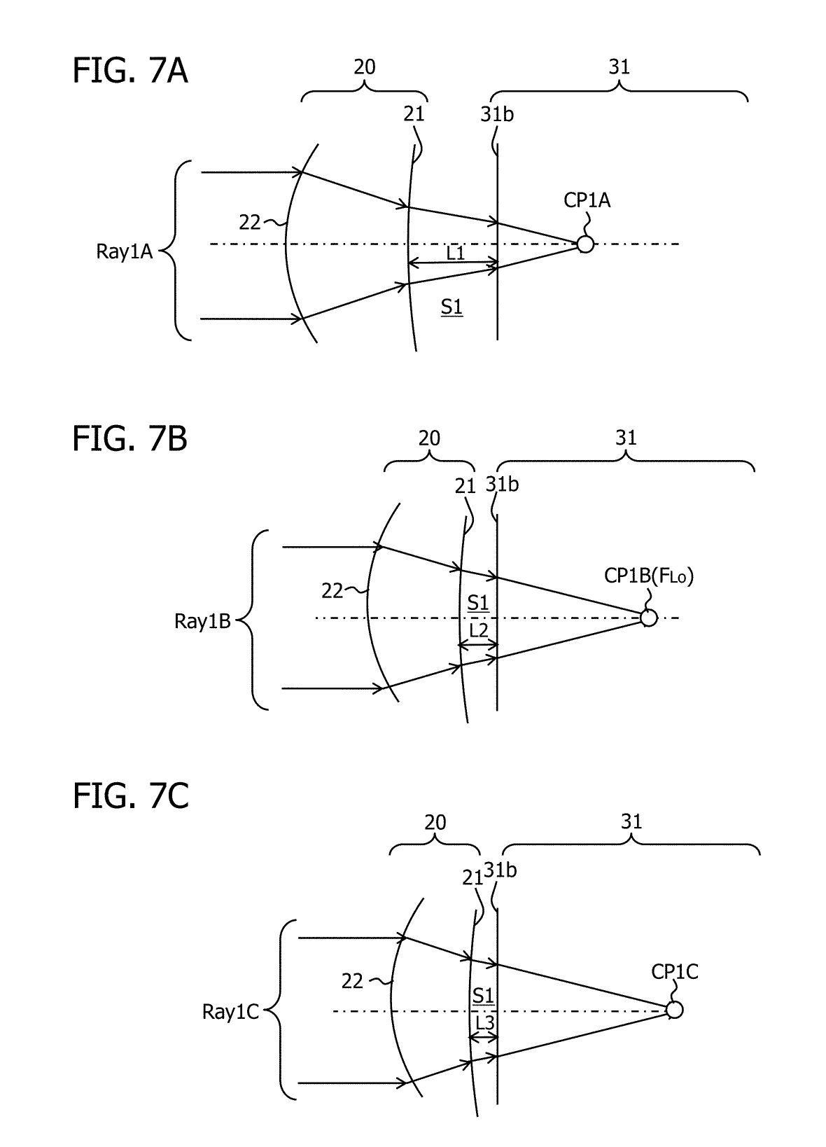

First the focal line that is formed when the curvature of the first exit surface 31b in the longitudinal section is the same in each longitudinal section will be described with reference to FIG. 6 and FIGS. 7A to 7C. FIG. 6 is the same as FIG. 4, except that the curvature of the first exit surface 31b in the longitudinal section is the same in each longitudinal section, and the positions of the focal lines and focal points (condensed points) are different.

FIG. 6 is a lateral sectional view of the vehicular lamp fitting 10 (portions other than the major optical surface are omitted). In FIG. 6, the focal lines FL1L and FL1R, which are formed when the curvature of the first exit surface 31b in the longitudinal section is the same in each longitudinal section, are indicated.

FIG. 7A indicates A2-A2 cross-section (longitudinal section) in FIG. 6. In FIG. 7A, a horizontal ray group Ray 1A, which passes through the A2-A2 cross-section of the front lens body 20, is illustrated.

As illustrated in FIG. 7A, when the horizontal ray group Ray 1A included in the A2-A2 cross-section enters the rear lens unit 31 through the front lens body 20, the horizontal ray group condenses at a point ahead of the focal point F_{Lo} (see FIG. 7B), and forms a condensed point CP1A.

In the same manner, when the horizontal ray group included in each of a plurality of longitudinal sections (a plurality of longitudinal sections having mutually different inclination angles with respect to the optical axis AX_{Lo}) between the A2-A2 cross-section and the B2-B2 cross-section enters the rear lens unit 31 through the front lens body 20 as well, the horizontal ray group condenses at a point ahead of the focal point F_{Lo} and forms a condensed point (group), although this is not illustrated.

The condensed point group, such as the condensed point CP1A, formed by being condensed at a point ahead of the focal point F_{Lo} like this, constitutes the focal line FL1L, as indicated by the dotted line on the left side of the optical axis AX_{Lo} in FIG. 6.

FIG. 7B indicates B2-B2 cross-section (longitudinal section) in FIG. 6. In FIG. 7B, a horizontal ray group Ray 1B, which passes through the B2-B2 cross-section of the front lens body 20, is illustrated.

As illustrated in FIG. 7B when the horizontal ray group Ray 1B included in the B2-B2 cross-section enters the rear lens unit 31 through the front lens body 20, the horizontal ray group condenses at the focal point F_{Lo}, and forms a condensed point CP1B.

FIG. 7C indicates C2-C2 cross-section (longitudinal section) in FIG. 6. In FIG. 7C, a horizontal ray group Ray 1C, which passes through the C2-C2 cross-section of the front lens body 20, is illustrated.

As illustrated in FIG. 7C when the horizontal ray group Ray 1C included in the C2-C2 cross-section enters the rear lens unit 31 through the front lens body 20, the horizontal ray group condenses at a point behind of the focal point F_{Lo}, and forms a condensed point CP1C.

In the same manner, when the horizontal ray group included in each of a plurality of longitudinal sections (a plurality of longitudinal sections having mutually different inclination angles with respect to the optical axis AX_{Lo}) between the B2-B2 cross-section and the C2-C2 cross-section enters the rear lens unit 31 through the front lens body 20 as well, the horizontal ray group condenses at a point behind the focal point F_{Lo} and forms a condensed point (group), although this is not illustrated.

The condensed point group, such as the condensed point CP1C, formed by being condensed at a point behind of the focal point F_{Lo} like this, constitutes the focal line FL1R, as indicated by the dotted line on the right side of the optical axis AX_{Lo} in FIG. 6.

The focal line FL1L and the focal line FL1R are laterally asymmetric with respect to the optical axis AX_{Lo} in FIG. 6. This is because the distance between the second entry surface 21 and the first exit surface 31b, through which each horizontal ray group passes through, is different depending on the horizontal ray group (e.g. see the distances L1, L2 and L3 in FIG. 7, L1>L2>L3).

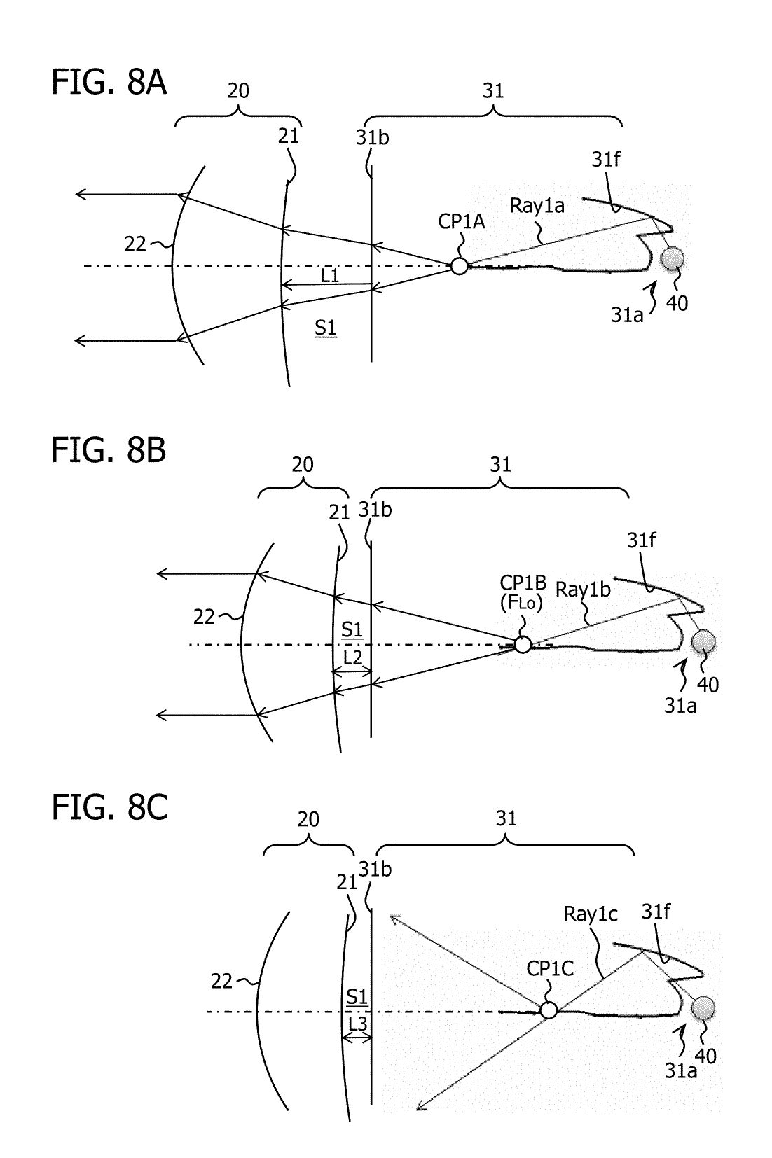

The optical path of the light coming from the light source 40 that passes through the vicinity of the focal lines FL1L and FL1R (edges 31c disposed along the focal lines FL1L and FL1R), configured as above, will be described with reference to FIGS. 8A to 8C.

FIG. 8A is the A2-A2 cross-section (longitudinal section) in FIG. 6. In FIG. 8A, a light Ray 1a from the light source 40, that passes through the A2-A2 cross-section in the rear lens unit 31, is illustrated.

As illustrated in FIG. 8A, in the A2-A2 cross-section, the light Ray 1a from the light source 40, which entered the rear lens unit 31 through the first entry surface 31a (peripheral entry surface 31a2), is internally reflected by the peripheral reflection surface 31f, and passes through the vicinity of the condensed point CP1A (focal line FL1L), passes through the vicinity of the condensed point CP1A at a relatively shallow angle (angle within a capture angle of the first exit surface 31b). Therefore the light Ray 1a exits through the first exit surface 31b, passes through the front lens body 20, and is irradiated forward, so as to form the low beam light distribution pattern.

This is the same for the light coming from the light source 40, which enters the rear lens unit 31 through the first entry surface 31a (peripheral entry surface 31a2), is internally reflected by the peripheral reflection surface 31f, and passes through the condensed point (focal line FL1L), in each of a plurality of longitudinal sections (a plurality of longitudinal sections having mutually different inclination angles with respect to the optical axis AX_{Lo}) between the A2-A2 cross-section and the B2-B2 cross-section, although this is not illustrated.

FIG. 8B is the B2-B2 cross-section (longitudinal section) in FIG. 6. In FIG. 8B, a light Ray 1b from the light source 40, that passes through the B2-B2 cross-section in the rear lens unit 31, is illustrated.

As illustrated in FIG. 8B, in the B2-B2 cross-section, the light Ray 1b from the light source 40, which entered the rear lens unit 31 through the first entry surface 31a (peripheral entry surface 31a2), is internally reflected by the peripheral reflection surface 31f, and passes through the vicinity of the condensed point CP1B (focal point F_{Lo}), passes through the vicinity of the condensed point CP1B (focal point F_{Lo}) at a relatively shallow angle (angle within a capture angle of the first exit surface 31b). Therefore the light Ray 1b exits through the first exit surface 31b, passes through the front lens body 20, and is irradiated forward, so as to form the low beam light distribution pattern.

FIG. 8C is the C2-C2 cross-section (longitudinal section) in FIG. 6. In FIG. 8C, a light Ray 1c from the light source 40, that passes through the C2-C2 cross-section in the rear lens unit 31, is illustrated.

As illustrated in FIG. 8C, in the C2-C2 cross-section, the light Ray 1c from the light source 40, which entered the rear lens unit 31 through the first entry surface 31a (peripheral entry surface 31a2), is internally reflected by the peripheral reflection surface 31f, and passes through the vicinity of the condensed point CP1C (focal line FL1R), passes through the vicinity of the condensed point CP1C at a relatively deep angle (angle outside a capture angle of the first exit surface 31b). Therefore the light Ray 1c does not exits through the first exit surface 31b, and is not used to form the low beam light distribution pattern.

This is the same for the light coming from the light source 40, which enters the rear lens unit 31 through the first entry surface 31a (peripheral entry surface 31a2), is internally reflected by the peripheral reflection surface 31f, and passes through the condensed point (focal line FL1R), in each of a plurality of longitudinal sections (a plurality of longitudinal sections having mutually different inclination angles with respect to the optical axis AX_{Lo}) between the B2-B2 cross-section and the C2-C2 cross-section, although this is not illustrated.

The light coming from the light source 40, such as Ray 1c, which passes through the vicinity of the focal line FL1R, passes through the vicinity of the edge 31c (focal line FL1R) at a relatively deep angle (an angle other than a capture angle of the first exit surface 31b). Therefore the light does not exit through the first exit surface 31b, and is not used to form the low beam light distribution pattern. As a result, the luminous intensity drops in a part of the low beam light distribution pattern (in a range enclosed by the square B1 in FIG. 5A).

A configuration to suppress the relative drop of the luminous intensity in a part of the low beam light distribution pattern will be described next.

As a result of intensive studies to suppress the generation of the relative drop of the luminous intensity in a part of the low beam light distribution pattern, the present inventors discovered that the generation of the relative drop of the luminous intensity in a part of the low beam light distribution pattern can be suppressed by adjusting the curvature of the first exit surface 31b in the longitudinal section for each longitudinal section.

This adjustment is an adjustment for correcting the focal lines FL1L and FL1R shown in FIG. 6 into focal lines (e.g. focal lines FL2L and FL2R shown in FIG. 4) extending in the vehicle width direction. This adjustment is performed using a predetermined simulation software.

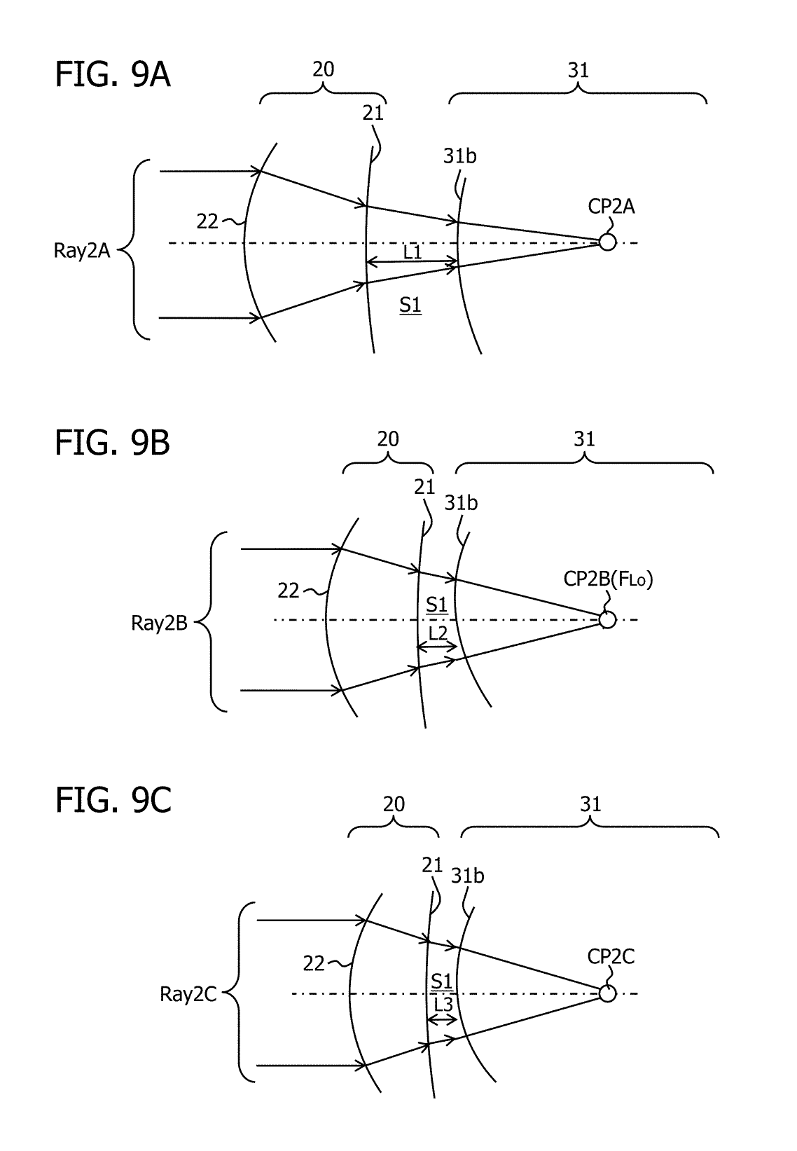

The focal lines that are generated after adjusting the curvature of the first exit surface 31b in the longitudinal section for each longitudinal section will be described next with reference to FIGS. 9A to 9C. FIG. 4 indicates the focal lines FL2L and FL2R which are formed after adjusting the curvature of the first exit surface 31b in the longitudinal section for each longitudinal section.

FIG. 9A indicates the A1-A1 cross-section (longitudinal section) in FIG. 4. In FIG. 9A, the horizontal ray group Ray 2A, which passes through the A1-A1 cross-section of the front lens body 20, is illustrated. In FIG. 9A, the curvature of the first exit surface 31b in the longitudinal section is adjusted (set) to a first curvature, so that when the horizontal ray group Ray 2A included in the A1-A1 cross-section enters the rear lens unit 31 through the front lens body 20, the horizontal ray group is condensed and forms a condensed point CP2A in the vicinity of the reference axis AX2 (see FIG. 4). As illustrated in FIG. 4, the reference axis AX2 is a horizontal line that is orthogonal to the optical axis AX_{Lo}, for example, and passes through the focal point F_{Lo}.

In the same manner, the curvature of each of a plurality of longitudinal sections (a plurality of longitudinal sections having mutually different inclination angles with respect to the optical axis AX_{Lo}) between the A1-A1 cross-section and the B1-B1 cross-section is also adjusted (set) so that when the horizontal ray group included in each of the plurality of longitudinal sections enters the rear lens unit 31 through the front lens body 20, the horizontal ray group is condensed and forms a condensed point (group) in a vicinity of the reference axis AX2 (not shown).

By adjusting the curvature like this, the condensed point group, such as CP2A, forms the focal line FL2L which extends in the vehicle width direction along the reference axis AX2, as indicated by the solid line on the left side of the optical axis AX_{Lo} in FIG. 4.

FIG. 9B indicates the B1-B1 cross-section (longitudinal section) in FIG. 4. In FIG. 9B, the horizontal ray group Ray 2B, which passes through the B1-B1 cross-section of the front lens body 20, is illustrated. In FIG. 9B, the curvature of the first exit surface 31b in the longitudinal section is adjusted (set) to a second curvature (the second curvature>first curvature), so that when the horizontal ray group Ray 2B included in the B1-B1 cross-section enters the rear lens unit 31 through the front lens body 20, the horizontal ray group is condensed and forms a condensed point CP2B in the vicinity of the reference axis AX2 (see FIG. 4).

FIG. 9C indicates the C1-C1 cross-section (longitudinal section) in FIG. 4. In FIG. 9C, the horizontal ray group Ray 2C, which passes through the C1-C1 cross-section of the front lens body 20, is illustrated. In FIG. 9C, the curvature of the first exit surface 31b in the longitudinal section is adjusted (set) to a third curvature (the third curvature>the second curvature), so that when the horizontal ray group Ray 2C included in the C1-C1 cross-section enters the rear lens unit 31 through the front lens body 20, the horizontal ray group is condensed and forms a condensed point CP2C in the vicinity of the reference axis AX2 (see FIG. 4).

In the same manner, the curvature of each of a plurality of longitudinal sections (a plurality of longitudinal sections having mutually different inclination angles with respect to the optical axis AX_{Lo}) between the B1-B1 cross-section and the C1-C1 cross-section is also adjusted (set) so that when the horizontal ray group included in each of the plurality of longitudinal sections enters the rear lens unit 31 through the front lens body 20, the horizontal ray group is condensed and forms a condensed point (group) in a vicinity of the reference axis AX2 (not shown).

By adjusting the curvature like this, the condensed point group, such as CP2C, forms the focal line FL2R which extends in the vehicle width direction along the reference axis AX2, as indicated by the solid line on the right side of the optical axis AX_{Lo} in FIG. 4.

The focal lines FL2L and FL2R formed like this may not perfectly match with the reference axis AX2, as long as the focal lines FL2L and FL2R are disposed along the reference axis AX2.

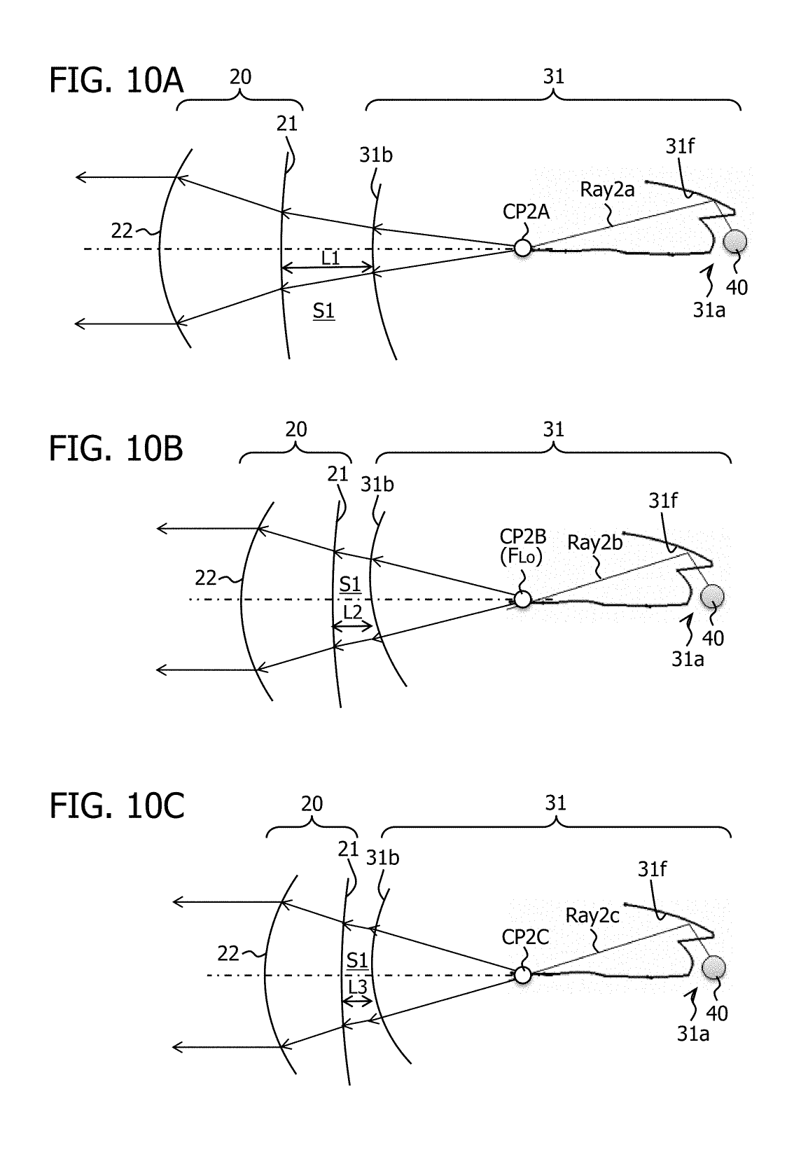

The optical path of the light coming from the light source 40, which passes in the vicinity of the focal lines FL2L and FL2R (edge 31c disposed along the focal line FL2L and FL2R) formed as mentioned above, will be described next with reference to FIGS. 10A to 10C.

FIG. 10A indicates the A1-A1 cross-section (longitudinal section) in FIG. 4. In FIG. 10A, light Ray 2a from the light source 40, which passes through the A1-A1 cross-section of the rear lens unit 31, is illustrated.

As illustrated in FIG. 10A, in the A1-A1 cross-section, the light Ray 2a from the light source 40, which entered the rear lens unit 31 through the first entry surface 31a (peripheral entry surface 31a2), is internally reflected by the peripheral reflection surface 31f, and passes through the vicinity of the condensed point CP2A (focal line FL2L), passes through the vicinity of the condensed point CP2A at a relatively shallow angle (angle within a capture angle of the first exit surface 31b). Therefore the light Ray 2a exits through the first exit surface 31b, passes through the front lens body 20, and is irradiated forward, so as to form the low beam light distribution pattern.

This is the same for the light coming from the light source 40, which enters the rear lens unit 31 through the first entry surface 31a (peripheral entry surface 31a2), is internally reflected by the peripheral reflection surface 31f, and passes through the condensed point (focal line FL2L), in each of a plurality of longitudinal sections (a plurality of longitudinal sections having mutually different inclination angles with respect to the optical axis AX_{Lo}) between the A1-A1 cross-section and the B1-B1 cross-section, although this is not illustrated.

FIG. 10B is the B1-B1 cross-section (longitudinal section) in FIG. 4. In FIG. 10B, a light Ray 2b from the light source 40, that passes through the B1-B1 cross-section in the rear lens unit 31, is illustrated.

As illustrated in FIG. 10B, in the B1-B1 cross-section, the light Ray 2b from the light source 40, which entered the rear lens unit 31 through the first entry surface 31a (peripheral entry surface 31a2), is internally reflected by the peripheral reflection surface 31f, and passes through the vicinity of the condensed point CP2B (focal point F_{Lo}), passes through the vicinity of the condensed point CP2B (focal point F_{Lo}) at a relatively shallow angle (angle within a capture angle of the first exit surface 31b). Therefore the light Ray 2b exits through the first exit surface 31b, passes through the front lens body 20, and is irradiated forward, so as to form the low beam light distribution pattern.

FIG. 10C is the C1-C1 cross-section (longitudinal section) in FIG. 4. In FIG. 10C, a light Ray 2c from the light source 40, that passes through the C1-C1 cross-section in the rear lens unit 31, is illustrated.

As illustrated in FIG. 10C, in the C1-C1 cross-section, the light Ray 2c from the light source 40, which entered the rear lens unit 31 through the first entry surface 31a (peripheral entry surface 31a2), is internally reflected by the peripheral reflection surface 31f, and passes through the vicinity of the condensed point CP2C (focal line FL2R), passes through the vicinity of the condensed point CP2C at a relatively shallow angle (angle within a capture angle of the first exit surface 31b), unlike FIG. 8C. Therefore the light Ray 2c exits through the first exit surface 31b, passes through the front lens body 20, and is irradiated forward, so as to form the low beam light distribution pattern.

This is the same for the light coming from the light source 40, which enters the rear lens unit 31 through the first entry surface 31a (peripheral entry surface 31a2), is internally reflected by the peripheral reflection surface 31f, and passes through the condensed point (focal line FL2R), in each of a plurality of longitudinal sections (a plurality of longitudinal sections having mutually different inclination angles with respect to the optical axis AX_{Lo}) between the B1-B1 cross-section and the C1-C1 cross-section, although this is not illustrated.

FIG. 5B is an example of the low beam light distribution pattern which is formed when the curvature of the first exit surface 31b in the longitudinal section is adjusted for each longitudinal section, as described above. FIG. 5B indicates an example of the low beam light distribution pattern, which is formed on a virtual vertical screen facing the front surface of the vehicle.

According to FIG. 5B, the luminous intensity near the cut-off area at 5 to 20° to the left is higher than the low beam light distribution pattern (low beam light distribution pattern which is formed when a curvature of the first exit surface 31b in the longitudinal section is the same in each longitudinal section), illustrated in FIG. 5A, for example, and the generation of a relative drop of the luminous intensity in a part of the low beam light distribution pattern (luminous intensity in a range enclosed by the square B2 in FIG. 5B) is suppressed.

This is because the light coming from the light source 40, such as Ray 2c, which passes through the vicinity of the focal line FL2R, passes through the vicinity of the edge 31c (focal line FL2R) at a relatively shallow angle (an angle within a capture angle of the first exit surface 31b), as illustrated in FIG. 10C. And as a result, the luminous intensity in a part of the low beam light distribution pattern (luminous intensity in a range enclosed by the square B2 in FIG. 5B) increases as illustrated in FIG. 5B.

As described above, according to this embodiment, a vehicular lamp fitting 10 which suppresses the generation of a relative drop of the luminous intensity in a part of the low beam light distribution pattern (generation of a blurred state), is provided, even if the front lens body 20 is disposed in an attitude that is inclined at a predetermined receding angle θ1, as illustrated in FIG. 1.

This is because the curvature of the first exit surface 31b in a longitudinal section is different in each longitudinal section (see FIG. 10).

In concrete terms, this is because the curvature of the first exit surface 31b in the longitudinal section is adjusted (set) for each longitudinal section, so that when the horizontal ray group included in each of a plurality of longitudinal sections (vertical surfaces) having mutually different inclination angles with respect to the optical axis AX_{Lo} enters the rear lens unit 31 through the front lens body 20 from the front side of the front lens body 20, the horizontal ray group is condensed and forms two focal lines FL2L and FL2R (condensed point group) along the reference axis AX2, in the vicinity of the reference axis AX2.

In other words, the curvature of the first exit surface 31b in the longitudinal cross-section is adjusted for each longitudinal section, so as to be larger as the distance decreases between the second entry surface 21 and the first exit surface 31b, where the horizontal ray group included in each of the plurality of vertical surfaces having mutually different inclination angles with respect to the optical axis AX_{Lo}, passes (see FIG. 10A to FIG. 10C).

Further, the first exit surface 31b is not only a curved surface which mainly condenses light in the first direction, but also has a curved surface (curved surface in the longitudinal direction) which has a condensing function in the second direction, and this curved surface in the longitudinal direction is adjusted (set) so that the curvature increases in the declining direction of the front lens (right to left in FIG. 4).

The first exit surface 31b may be a freeform surface. For example, the first exit surface 31b may be a freeform surface of which surface shape is adjusted (set) so that when the horizontal ray group included in each of a plurality of longitudinal sections (vertical surfaces) having mutually different inclination angles with respect to the optical axis AX_{Lo} (hereafter horizontal ray group A) enters the rear lens unit 31 through the front lens body 20 from the front side of the front lens body 20, the horizontal ray group is condensed and forms the focal lines FL2L and FL2R (condensed point group) along the reference axis AX2 in the vicinity of the reference axis AX2.

The first exit surface 31b (freeform surface) is configured, for example, as follows. For example, the first exit surface 31b can be configured by changing (adjusting) the surface shape of a reference surface (a surface to be a base of the first exit surface 31b, such as a curved surface that is convex in the forward direction) using a predetermined simulation software, so that the horizontal ray group A, which entered the rear lens unit 31 through the front lens body 20 (in the sequence of the second exit surface 22, the second entry surface 21 and the first exit surface 31b) from the front side of the front lens body 20, is condensed in the vicinity of the reference axis AX2, and forms the focal lines FL2L and FL2R (condensed point group) along the reference axis AX2.

Thereby the generation of the relative drop of the luminous intensity in a part of the low beam light distribution pattern is suppressed, even if the front lens body 20 is disposed in an attitude inclined at a predetermined receding angle θ1, as illustrated in FIG. 1.

Further, according to Embodiment 1, both the second entry surface 21 and the second exit surface 22 are configured as cylindrical surfaces, which are convex in the forward direction and of which cylindrical axes extend in the first direction (see FIG. 3), in other words, not only the second exit surface 22 but also the second entry surface 21 can condense the light in the second direction. Hence, compared with the case of the above mentioned prior art, where the second entry surface is a plane and only the second exit surface condenses light in the second direction, the thickness of the front lens body 20 in the optical axis AX_{Lo} direction can be decreased while maintaining the condensing rate. As a consequence, the material cost of the front lens body 20 can be reduced (cost reduction).

A modification will be described next.

In Embodiment 1, an example of suppressing the generation of a relative drop of luminous intensity in a part of the low beam light distribution pattern by making the curvature of the first exit surface 31b in the longitudinal section different for each longitudinal section was described, but the present invention is not limited to this.

For example, the curvature of the first exit surface 31b in the longitudinal section may be the same in each longitudinal section, and the curvature of the second entry surface 21 in the longitudinal section may be different for each longitudinal section.

For example, the curvature of the second entry surface 21 in the longitudinal section is adjusted (set) for each longitudinal section, so that when the horizontal ray group included in each of a plurality of longitudinal sections enters the rear lens unit 31 through the front lens body 20, the horizontal ray group condenses and forms the condensed point (group) in the vicinity of the reference axis AX2.

In other words, the curvature of the second entry surface 21 in the longitudinal cross-section is adjusted for each longitudinal section, so as to be larger as the distance between the second entry surface 21 and the first exit surface 31b, where the horizontal ray group included in each of the plurality of vertical surfaces having mutually different inclination angles with respect to the optical axis AX_{Lo}, passes, is shorter.

The second entry surface 21 includes a curved surface (curved surface in the longitudinal direction) which has a function to condense the light in the second direction, and the curved surface in the longitudinal direction is adjusted (set) such that the curvature or the condensing power increases in the declining direction of the front lens (right to left in FIG. 4).

The second entry surface 21 may be a freeform surface, such like the first exit surface 31b.

This configuration also suppresses the generation of the relative drop of luminous intensity in a part of the low beam light distribution pattern.

Further, along with the curvature (or condensing power) of the longitudinal section of the first exit surface 31b, the curvature (or condensing power) of the longitudinal section of the second entry surface 21 may be different in each longitudinal section. For example, in the case where the horizontal ray group included in each of the plurality of longitudinal sections enters the rear lens unit 31 through the front lens body 20, the curvatures of the first exit surface 31b and the second entry surface 21 of the longitudinal sections are adjusted (set) for each longitudinal section, so that the horizontal ray group is condensed and forms a condensed point (group) in the vicinity of the reference axis AX2. This configuration also suppresses the generation of the relative drop of luminous intensity in a part of the low beam light distribution pattern.

### Embodiment 2

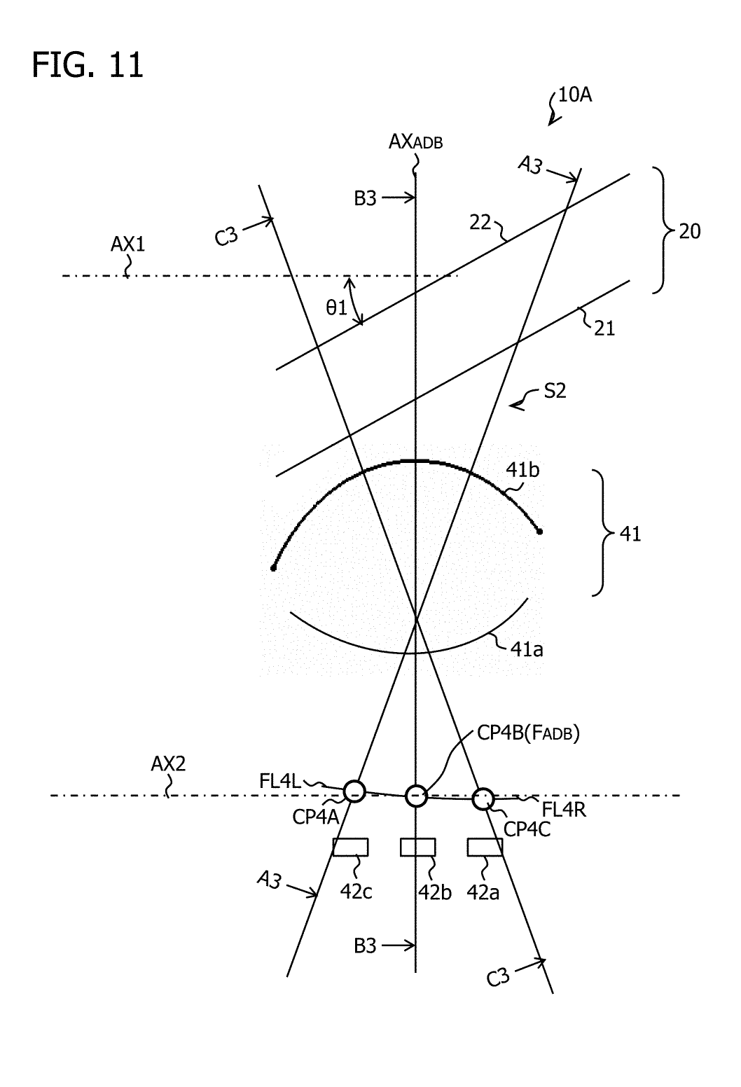

Next as Embodiment 2, a vehicular lamp fitting 10A which includes: a rear lens unit 41 instead of the rear lens unit 31; and a plurality of light sources 42a to 42c instead of the light source 40, will be described with reference to FIG. 11. The other configurations are the same as those in Embodiment 1. In the following, the primary differences from Embodiment 1 will be described, and a composing element the same as Embodiment 1 is denoted with a same reference symbol, and description thereof may be omitted. FIG. 11 is a lateral sectional view of the vehicular lamp fitting 10A of Embodiment 2 (portions other than the major optical surface are omitted).

As illustrated in FIG. 11, the vehicular lamp fitting 10A is a vehicular lamp fitting configured to form an ADB light distribution pattern, and includes: a front lens body 20; a rear lens unit 41 disposed behind the front lens body 20; and a plurality of light sources 42a to 42c, that are disposed behind the rear lens unit 41, and that emit respective light which passes through the rear lens unit 41 and the front lens body 20 in this order, and is irradiated forward, so as to form an ADB light distribution pattern. A plurality of rear lens unit 41 and a plurality of light sources 42a to 42c may be used.

The front lens body 20 and the rear lens unit 41 are made of transparent resin such as acrylic and polycarbonate. The front lens body 20 and the rear lens unit 41 are separately molded in a physically separated state by injection molding. The front lens body 20 and the rear lens unit 41 are configured as a lens body connected by a holding member (not shown) such as a lens holder.

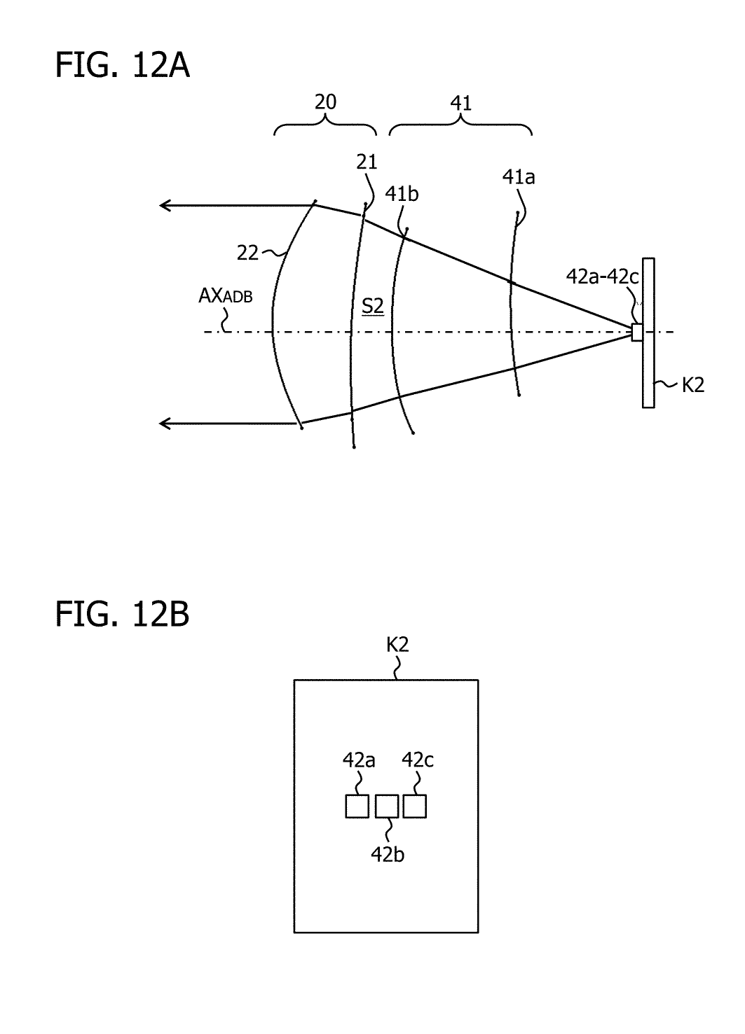

FIG. 12A is a B3-B3 sectional view of the vehicular lamp fitting 10A illustrated in FIG. 11 (portions other than the major optical surface are omitted). In FIG. 11, FIG. 12A and the like, the line extending in the vehicle length direction, indicated by the reference symbol AX_{ADB}, is an optical axis of a projection lens, which is configured by the front lens body 20 and the rear lens unit 41. The optical axis is hereafter referred to as the optical axis AX_{ADB}.

FIG. 12B is a front view of a substrate K2 on which the light sources 42a to 42c are mounted.

As illustrated in FIG. 12B, the light source 42a to 42c are semiconductor light emitting element such as an LED or LD having a rectangular (for example, a 1 mm²) light emitting surface and are mounted to a substrate K2 with the light emitting surface facing forward (to the front). The light sources 42a to 42c are arranged in a line in the horizontal direction. The substrate K2 is mounted to the housing (not shown) using a screw or another means.

As illustrated in FIG. 12B, the rear lens unit 41 includes a first entry surface 41a, and a first exit surface 41b on the side opposite to the first entry surface 41a. The rear lens unit 41 is mainly responsible for condensing the light from the light sources 42a to 42c passing through the rear lens unit 41 in the first direction.

The first entry surface 41a is a surface through which the respective light coming from the light sources 42a to 42c enters the rear lens unit 41. The first entry surface 41a is configured as a curved surface which is convex in the forward direction. The curvature of the first entry surface 41a in the longitudinal section is the same in each longitudinal section, and the curvature of the first entry surface 41a in the lateral section is the same in each lateral section.

The first exit surface 41b is a surface through which the respective light coming from the light sources 42a to 42c, which entered the rear lens unit 41 through the first entry surface 41a, exits.

As illustrated in FIG. 11, the first exit surface 41b is configured as a curved surface that is convex in the forward direction in the lateral section. The curvature of the first exit surface 41b is the same in each lateral section. On the other hand, the curvature of the first exit surface 41b is not the same in each longitudinal section, but is different in each longitudinal section. For example, the curvature of the first exit surface 41b in the longitudinal section is different in the A3-A3 cross-section, B3-B3 cross section, and C3-C3 cross section respectively in FIG. 11. It will be described later how the curvature of the longitudinal cross section of the first exit surface 41b differs in each longitudinal cross section.

The light sources 42a to 42c are disposed along the focal line, as mentioned later.

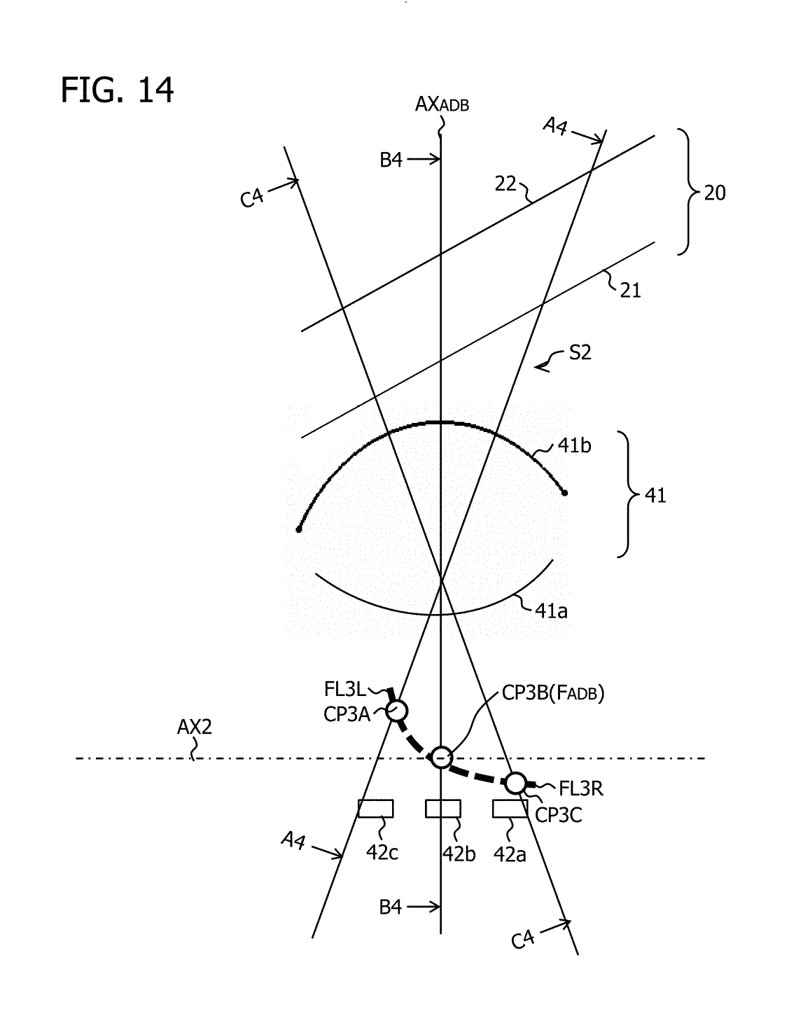

The focal line is a group of condensed points which are formed behind the rear lens unit 41, when a plurality of horizontal rays, which are included in a plurality of vertical surfaces having mutually different inclination angles with respect to the optical axis AX_{ADB} respectively, passes through the front lens body 20 and the rear lens unit 41 from the front side of the front lens body 20. The solid lines indicated by the reference symbols FL4L and FL4R in FIG. 11 and the dotted lines indicated by the reference symbols FL3L and FL3R in FIG. 14 are examples of the focal line. These lines are hereafter referred to as the focal line FL3L, focal line FL3R, focal line FL4L and focal line FL4R. The focal lines FL3L, FL3R, FL4L and FL4R will be described in detail later.

In the vehicular lamp fitting 10A having the above-described configuration, when the light sources 42a to 42c are turned on, the light from the light sources 42a to 42c enters the rear lens units 41 from the first entry surface 41a and exits from the first exit surface 41b. At this time, the first exit surface 41b (lateral section of the first exit surface 41b) acts to condense, in the first direction, the light from the light source 42a to 42c which exits the first exit surface 41b. Then, the light from the light source 42a to 42c which has exited the first exit surface 41b passes through a space S2 between the rear lens unit 41 and the front lens body 20, further enters the front lens body 20 from the second entry surface 21 and is irradiated forward after exiting the second exit surface 22. At this time, the second exit surface 22 acts to condense, in the second direction, the light from the light source 42a to 42c which exit the second exit surface 22. Thereby, the ADB light distribution pattern is formed.

In other words, the light source images of the light sources 42a to 42c are inverted and projected forward by the rear lens unit 41 and the front lens body 20, which function as the projection lens. Thereby the ADB light distribution pattern is formed.

An ADB light distribution pattern which is formed when a curvature of the first exit surface 41b in the longitudinal section is the same in each longitudinal section will be described next.

FIG. 13 is an example of the ADB light distribution pattern which is formed when a curvature of the first exit surface 41b in the longitudinal section is the same in each longitudinal section. FIG. 13 indicates an example of the ADB light distribution pattern which is formed on a virtual vertical screen facing the front surface of the vehicle.

As illustrated in FIG. 13, the ADB light distribution pattern includes a plurality of irradiation regions P1 to P3 which are horizontally disposed on a line in the high beam region. The irradiation regions P1 to P3 are independently turned ON/OFF (including lighting in the dimmed state) in accordance with the turning ON/OFF of the light sources 42a to 42c (including lighting in the dimmed state). FIG. 13 indicates an example of the ADB light distribution pattern which is formed in the state that the light sources 42a to 42c are lit (fully lit) respectively.

The present inventors performed simulation and confirmed that a part of the ADB light distribution pattern is stretched longitudinally and a relative drop of the luminous intensity in a part of the ADB light distribution pattern is generated (a blurred state is generated) when the front lens body 20 is disposed in an attitude that is inclined with respect to the reference axis AX1 at a receding angle θ1, when viewed from the top, if the curvature of the first exit surface 41b in the longitudinal section is the same in each longitudinal section, as illustrated in FIG. 11.

According to FIG. 13, a part of the ADB light distribution pattern (the portion indicated by the arrow mark AR1) is stretched more than the portion indicated by the arrow mark AR2 in the longitudinal direction, and the luminous intensity in this part has relatively dropped. The reason for the generation of this drop of luminous intensity in a part of the ADB light distribution pattern is the same as that described in Embodiment 1 with reference to FIG. 8C. This reason will be described in brief next.

First the focal line that is formed when the curvature of the first exit surface 41b in the longitudinal section is the same in each longitudinal section will be described with reference to FIG. 14.

FIG. 14 is a lateral sectional view of the vehicular lamp fitting 10A (portions other than the major optical surface are omitted). In FIG. 14, the focal lines FL3L and FL3R, which are formed when the curvature of the first exit surface 41b in the longitudinal section is the same in each longitudinal section, are indicated.

When the horizontal ray group included in the A4-A4 cross-section in FIG. 14 passes through the front lens body 20 and the rear lens unit 41, the horizontal ray group condenses at a point behind the rear lens unit 41 and ahead of the focal point F_{ADB}, and forms a condensed point CP3A.

The focal point F_{ADB} is a condensed point on the optical axis AX_{ADB} behind the rear lens unit 41, when the horizontal ray group, which is parallel with the optical axis AX_{Lo}, enters the rear lens unit 41 through the front lens body 20 from the front side of the front lens body 20.

In the same manner, as shown in FIG. 14, when the horizontal ray group included in each of the plurality of longitudinal sections (a plurality of longitudinal sections having mutually different inclination angles with respect to the optical axis AX_{ADB}) between the A4-A4 cross-section and the B4-B4 cross section, passes through the front lens body 20 and the rear lens unit 41 as well, the horizontal ray group condenses at a point behind the rear lens unit 41 and ahead of the focal point F_{ADB}, and forms a condensed point (group), although this is not illustrated.

The condensed point group, such as CP3A, formed by being condensed at a point behind the rear lens unit 41 and ahead of the focal point F_{ADB} like this, constitutes a focal line FL3L, as indicated by the dotted line on the left side of the optical axis AX_{ADB} in FIG. 14.

When the horizontal ray group included in the B4-B4 cross-section in FIG. 14 passes through the front lens body 20 and the rear lens unit 41, the horizontal ray group condenses at the focal point F_{ADB} behind the rear lens unit 41 and forms a condensed point CP3B.

When the horizontal ray group included in the C4-C4 cross-section in FIG. 14 passes through the front lens body 20 and the rear lens unit 41, the horizontal ray group condenses behind the rear lens unit 41 and the focal point F_{ADB}, and forms a condensed point CP3C.

In the same manner, as shown in FIG. 14, when the horizontal ray group included in each of the plurality of longitudinal sections (a plurality of longitudinal sections having mutually different inclination angles with respect to the optical axis AX_{ADB}) between the B4-B4 cross-section and the C4-C4 cross section, passes through the front lens body 20 and the rear lens unit 41 as well, the horizontal ray group condenses behind the rear lens unit 41 and the focal point F_{ADB}, and forms a condensed point (group), although this is not illustrated.

The condensed point group, such as CP3C, formed by being condensed at a point behind the rear lens unit 41 and behind the focal point F_{ADB} like this, constitutes a focal line FL3R, as indicated by the dotted line on the right side of the optical axis AX_{ADB} in FIG. 14.

The focal line FL3L and the focal line FL3R are laterally asymmetric with respect to the optical axis AX_{ADB} in FIG. 14. This is because the distance between the second entry surface 21 and the first exit surface 41b through which each horizontal ray group passes is different depending on the horizontal ray group.

When the light sources 42a to 42c are disposed with respect to the focal line FL3L and FL3R configured like this (see FIG. 14), the distance between the light sources 42a to 42c and the focal lines FL3L and FL3R changes depending on each light source 42a to 42c. For example, the distance between the light source 42a and the condensed point CP3C (focal line FL3R) is the shortest, and the distance between the light source 42c and the condensed point CP3A (focal line FL3L) is the longest. As a result, a part of the ADB light distribution pattern (the portion indicated by the arrow mark AR1 in FIG. 13) is stretched in the longitudinal direction, and a drop of the luminous intensity is generated (a blurred state is generated).

A configuration for suppressing that a part of ADB light distribution pattern is extended in the longitudinal direction and the light intensity decreases relatively will be described next.

As a result of intensive studies to suppress the generation of the relative drop of the luminous intensity in a part of the ADB light distribution pattern, the present inventors discovered that the generation of the relative drop of the luminous intensity in a part of the ADB light distribution pattern can be suppressed by adjusting the curvature of the first exit surface 41b in the longitudinal section for each longitudinal section.

This adjustment is an adjustment for correcting the focal lines FL3L and FL3R shown in FIG. 14 into focal lines (e.g. focal lines FL4L and FL4R shown in FIG. 11) extending in the vehicle width direction. This adjustment is performed using a predetermined simulation software.

The focal lines that are generated after adjusting the curvature of the first exit surface 41b in the longitudinal section for each longitudinal section will be described next with reference to FIG. 11.

In FIG. 11, the curvature of the first exit surface 41b in the A3-A3 cross-section is adjusted (set) to a first curvature, so that when the horizontal ray group included in the A3-A3 cross-section passes through the front lens body 20 and the rear lens unit 41, the horizontal ray group is condensed behind the rear lens unit 41 and forms a condensed point CP4A in the vicinity of the reference axis AX2.

In the same manner, the curvature of each of a plurality of longitudinal sections (a plurality of longitudinal sections having mutually different inclination angles with respect to the optical axis AX_{ADB}) between the A3-A3 cross-section and the B3-B3 cross-section is also adjusted (set) so that when the horizontal ray group included in each of the plurality of longitudinal sections passes through the front lens body 20 and the rear lens unit 41, the horizontal ray group is condensed behind the rear lens unit 41 and forms a condensed point (group) in a vicinity of the reference axis AX2.

By adjusting the curvature like this, the condensed point group, such as CP4A, forms the focal line FL4L which extends in the vehicle width direction along the reference axis AX2, as indicated by the solid line on the left side of the optical axis AX_{ADB} in FIG. 11.

In FIG. 11, the curvature of the first exit surface 41b in the B3-B3 cross-section is adjusted (set) to a second curvature (the second curvature>the first curvature), so that when the horizontal ray group included in the B3-B3 cross-section passes through the front lens body 20 and the rear lens unit 41, the horizontal ray group is condensed behind the rear lens unit 41 and forms a condensed point CP4B in the vicinity of the reference axis AX2.

In FIG. 11, the curvature of the first exit surface 41b in the C3-C3 cross-section is adjusted (set) to a third curvature (the third curvature>the second curvature), so that when the horizontal ray group included in the C3-C3 cross-section passes through the front lens body 20 and the rear lens unit 41, the horizontal ray group is condensed behind the rear lens unit 41 and forms a condensed point CP4C in the vicinity of the reference axis AX2.

In the same manner, the curvature of each of a plurality of longitudinal sections (a plurality of longitudinal sections having mutually different inclination angles with respect to the optical axis AX_{ADB}) between the B3-B3 cross-section and the C3-C3 cross-section is also adjusted (set) so that when the horizontal ray group included in each of the plurality of longitudinal sections passes through the front lens body 20 and the rear lens unit 41, the horizontal ray group is condensed behind the rear lens unit 41 and forms a condensed point (group) in a vicinity of the reference axis AX2.

By adjusting the curvature like this, the condensed point group, such as CP4C, forms the focal line FL4R which extends in the vehicle width direction along the reference axis AX2, as indicated by the solid line on the right side of the optical axis AX_{ADB} in FIG. 11.

When the light sources 42a to 42c are disposed with respect to the focal line FL4L and FL4R configured like this (see FIG. 11), the distance between the light sources 42a to 42c and the focal lines FL4L and FL4R does not change depending on each light source 42a to 42c and is substantially the same. As a result, it is suppressed that a part of the ADB light distribution pattern (the part indicated by the arrow AR1 in FIG. 13) is extended in the longitudinal direction and the light intensity decreases relatively (a blurred state is generated).

As described above, according to this embodiment, as shown in FIG. 11, a vehicular lamp fitting 10A, which suppresses the generation of a relative drop of the luminous intensity in a part of the ADB light distribution pattern (generation of a blurred state), can be provided, even if the front lens body 20 is disposed in an attitude that is inclined at a predetermined receding angle θ1.

This is because, as in the first embodiment (see FIG. 9), the curvature of the first exit surface 41b in a longitudinal section is different in each longitudinal section.

In concrete terms, this is because the curvature of the first exit surface 31b in the longitudinal section is adjusted (set) for each longitudinal section, so that when the horizontal ray group included in each of a plurality of longitudinal sections (vertical surfaces) having mutually different inclination angles with respect to the optical axis AX_{Lo} passes through the front lens body 20 and the rear lens unit 41, the horizontal ray group is condensed behind the rear lens unit 41 and forms two focal lines FL4L and FL4R (condensed point group) along the reference axis AX2.

In other words, the curvature of the first exit surface 41b in the longitudinal cross-section is adjusted for each longitudinal section, so as to be larger as the distance decreases between the second entry surface 21 and the first exit surface 41b, where the horizontal ray group included in each of the plurality of vertical surfaces having mutually different inclination angles with respect to the optical axis AX_{ADB}, passes.

Further, the first exit surface 41b is not only a curved surface which mainly condenses light in the first direction, but also has a curved surface (curved surface in the longitudinal direction) which has a condensing function in the second direction, and this curved surface in the longitudinal direction is adjusted (set) so that the curvature increases in the declining direction of the front lens.

The first exit surface 41b may be a freeform surface. For example, the first exit surface 41b may be a freeform surface of which surface shape is adjusted (set) so that when the horizontal ray group included in each of a plurality of longitudinal sections (vertical surfaces) having mutually different inclination angles with respect to the optical axis AX_{ADB} (hereafter horizontal ray group B) enters the rear lens unit 41 through the front lens body 20 from the front side of the front lens body 20, the horizontal ray group is condensed and forms the focal lines FL4L and FL4R (condensed point group) along the reference axis AX2 in the vicinity of the reference axis AX2.

The first exit surface 41b (freeform surface) is configured, for example, as follows. For example, the first exit surface 41b can be configured by changing (adjusting) the surface shape of a reference surface (a surface to be a base of the first exit surface 41b, such as a curved surface that is convex in the forward direction) using a predetermined simulation software, so that the horizontal ray group B, which entered the rear lens unit 41 through the front lens body 20 (in the sequence of the second exit surface 22, the second entry surface 21 and the first exit surface 41b) from the front side of the front lens body 20, is condensed in the vicinity of the reference axis AX2, and forms the focal lines FL4L and FL4R (condensed point group) along the reference axis AX2.

Thereby the generation of the relative drop of the luminous intensity in a part of the ADB light distribution pattern is suppressed, even if the front lens body 20 is disposed in an attitude inclined at a predetermined receding angle θ1, as illustrated in FIG. 11.

Further, according to Embodiment 2, both the second entry surface 21 and the second exit surface 22 are configured as cylindrical surfaces, which are convex in the forward direction and of which cylindrical axes extend in the first direction (see FIG. 3), in other words, not only the second exit surface 22 but also the second entry surface 21 can condense the light in the second direction. Hence, compared with the case of the above mentioned prior art, where the second entry surface is a plane and only the second exit surface condenses light in the second direction, the thickness of the front lens body 20 in the optical axis AX_{ADB} direction can be decreased while maintaining the condensing rate. As a consequence, the material cost of the front lens body 20 can be reduced (cost reduction).

A modification will be described next.

In Embodiment 2, an example of suppressing the generation of a relative drop of luminous intensity in a part of the ADB light distribution pattern by making the curvature of the first exit surface 41b in the longitudinal section different for each longitudinal section was described, but the present invention is not limited to this.

For example, the curvature of the first exit surface 41b in the longitudinal section may be the same in each longitudinal section, and the curvature of the longitudinal section of at least one of the first entry surface 41a and the second entry surface 21 may be different for each longitudinal section.

For example, the curvature of each of a plurality of longitudinal sections of the second entry surface 21 (or the first entry surface 41a) is adjusted (set) so that when the horizontal ray group included in each of the plurality of longitudinal sections passes through the front lens body 20 and the rear lens unit 41, the horizontal ray group is condensed behind the rear lens unit 41 and forms a condensed point (group) in a vicinity of the reference axis AX2. This also makes it possible to suppress a relative decrease in the light intensity of a part of the ADB light distribution pattern.

In other words, the curvature of the second entry surface 21 (or the first entry surface 41a) in the longitudinal cross-section is adjusted for each longitudinal section, so as to be larger as the distance between the second entry surface 21 and the first exit surface 41b, where the horizontal ray group included in each of the plurality of vertical surfaces having mutually different inclination angles with respect to the optical axis AX_{ADB}, passes, is shorter.

The second entry surface 21 (or the first entry surface 41a) includes a curved surface (curved surface in the longitudinal direction) which has a function to condense the light in the second direction. The curved surface in the longitudinal direction of the second entry surface 21 is adjusted (set) such that the curvature or the condensing power increases in the declining direction of the front lens (right to left in FIG. 4). The curved surface in the longitudinal direction of the first entry surface 41a is adjusted (set) such that the curvature or the condensing power decreases in the declining direction of the front lens.

The second entry surface 21 (or the first entry surface 41a) may be a freeform surface, such like the first exit surface 41b.

Also, for example, the curvature of at least one of the longitudinal sections of the first entry surface 41a and the second entry surface 21 may be made different for each of the longitudinal sections together with the curvature of the longitudinal section of the first exit surface 41b. For example, the curvature of each of a plurality of longitudinal sections of the first exit surface 41b and the second entry surface 21 are adjusted (set) so that when the horizontal ray group included in each of the plurality of longitudinal sections passes through the front lens body 20 and the rear lens unit 41, the horizontal ray group is condensed behind the rear lens unit 41 and forms a condensed point (group) in a vicinity of the reference axis AX2. This also makes it possible to suppress a relative decrease in the light intensity of a part of the ADB light distribution pattern.

### Embodiment 3

A vehicular lamp fitting 10B according to Embodiment 3 of the present invention will be described below with reference to the attached drawings. In each drawing, a corresponding composing element is denoted with a same reference symbol, and redundant description thereof will be omitted.

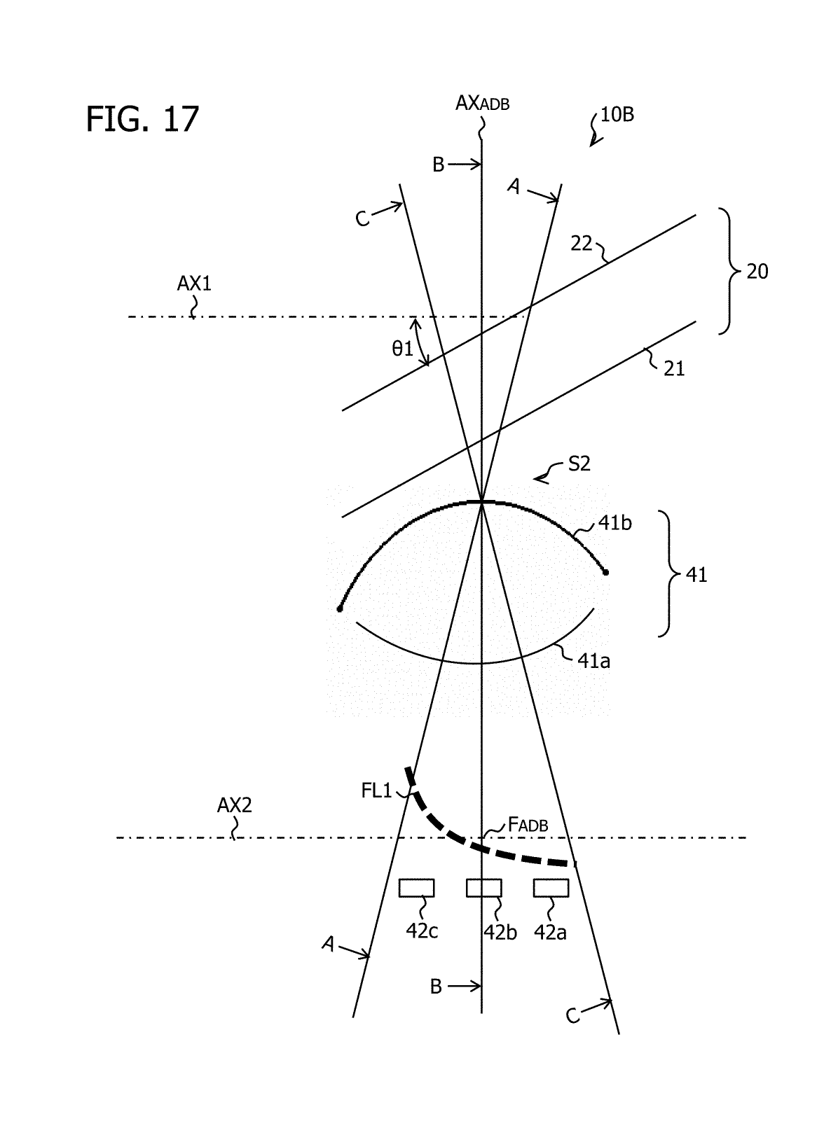

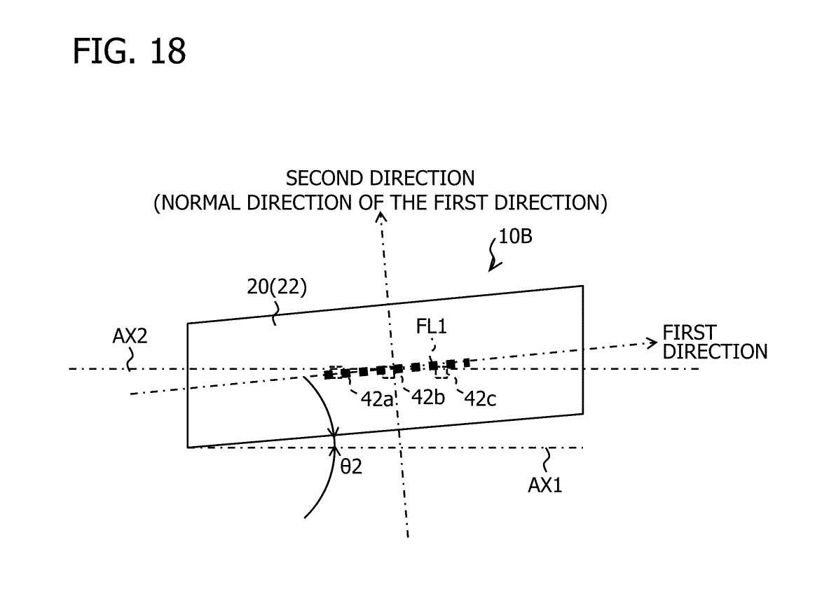

FIG. 17 is a top view of the vehicular lamp fitting 10B (portions other than the major optical surface are omitted). FIG. 18 is a front view of the vehicular lamp fitting 10B.

The vehicular lamp fitting 10B shown in FIGS. 1 to 2 is a vehicular headlamp (headlamp) that can form a ADB light distribution pattern and is mounted to, for example, the left and right sides on the front end of a vehicle such as an automobile. Because the vehicular lamp fitting 10B to be mounted to both the left and right sides has a symmetrical configuration, a vehicular lamp fitting 10B mounted to the left side at the front of a vehicle (left side facing the front of the vehicle) is described as a representative example of the vehicular lamp fitting 10B. Although not illustrated, the vehicular lamp fitting 10B is arranged in a lamp chamber constituted by an outer lens and a housing and is attached to the housing or the like.

As illustrated in FIG. 17 and FIG. 18, the vehicular lamp fitting 10B includes: a front lens body 20; a rear lens unit 41 disposed behind the front lens body 20; and a plurality of light sources 42a to 42c, that are disposed behind the rear lens units 41, and that emit respective light which passes through the rear lens units 41 and the front lens body 20 in this order, and is irradiated forward, so as to form a ADB light distribution pattern.

The front lens body 20 and the rear lens unit 41 are made of transparent resin such as acrylic and polycarbonate. The front lens body 20 and the rear lens unit 41 are separately molded in a physically separated state by injection molding. The front lens body 20 and the rear lens unit 41 are configured as a lens body connected by a holding member (not shown) such as a lens holder.

The front lens body 20 is a lens unit extending in a predetermined direction (also referred to as a first direction herein). The first direction is, for example, a direction inclined, with respect to a reference axis AX1 which extends in the vehicle width direction, at a receding angle θ1 when viewed from the top, as illustrated in FIG. 17, and also is a direction inclined, with respect to the reference axis AX1, at a upward angle θ2 when viewed from the front, as illustrated in FIG. 18. The angles θ1 is any angles from between 0° to 90°. The angle θ2 is any angle that is greater than 0 and less than 90°. To simplify description, an example where θ1 is 30° and θ2 is 5° will be described.

In a general vehicular lamp, one projection lens is responsible for condensing light in the first direction and light in the second direction orthogonal to the first direction. In contrast, in this embodiment, two lenses (the front lens body 20 and the rear lens unit 41) which make up a projection lens are responsible for condensing light in the first direction and light in the second direction orthogonal to the first direction. More specifically, in this embodiment, the rear lens unit 41 is mainly responsible for condensing light in the first direction and the front lens body 20 is mainly responsible for condensing light in the second direction.

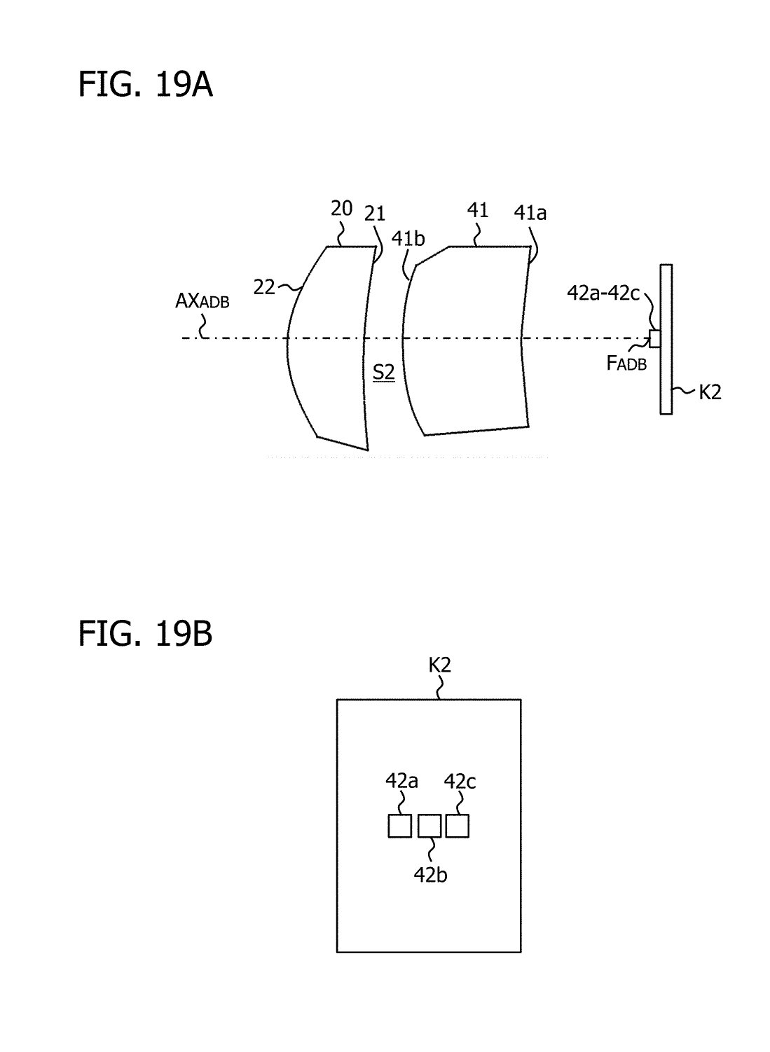

FIG. 19A is an B-B cross-sectional view of the vehicular lamp fitting 10B illustrated in FIG. 17. In FIG. 17, FIG. 19A and the like, the line extending in the vehicle length direction, indicated by the reference symbol AX_{ADB}, is an optical axis of a projection lens which is configured by the front lens body 20 and the rear lens unit 41. This optical axis is hereafter referred to as the optical axis AX_{ADB}.

As illustrated in FIG. 19A, the front lens body 20 includes a second entry surface 21 and a second exit surface 22 disposed on the opposite side of the second entry surface 21. The front lens body 20 is mainly responsible for condensing light from the rear lens unit 41 transmitting the front lens body 20 in the second direction. The second entry surface 21 and the second exit surface 22 extend in the first direction (e.g. see FIG. 18) respectively.

In concrete terms, as illustrated in FIG. 19A, the second entry surface 21 is configured as a cylindrical surface that is convex in the forward direction and of which cylindrical axis extends in the first direction. The second exit surface 22 is configured as a cylindrical surface that is convex in the forward direction and of which cylindrical axis extends in the first direction. The curvature (curvature of a cross-section orthogonal to the first direction) of the second entry surface 21 is the same in each cross-section. The curvature (curvature of a cross-section orthogonal to the first direction) of the second exit surface 22 is the same in each cross-section. The second entry surface 21 and the second exit surface 22 may be a plane or a planar surface.

FIG. 19B is a front view of the substrate K2 on which the light sources 42a to 42c are mounted.

As illustrated in FIG. 19B, the light source 42a to 42c are semiconductor light emitting element such as an LED or LD having a rectangular (for example, a 1 mm²) light emitting surface and are mounted to a substrate K2 with the light emitting surface facing forward (to the front). The light sources 42a to 42c are arranged in a line in the horizontal direction in the vicinity of the focal point F_{ADB} of the projection lens configured by the front lens body 20 and the rear lens unit 41. The substrate K2 is mounted to the housing (not shown) using a screw or another means.

The focal point F_{ADB} is a condensed point on the optical axis AX_{ADB} condensed behind the rear lens unit 41, when the horizontal ray group, which is parallel with the optical axis AX_{ADB}, enters the rear lens unit 41 through the front lens body 20 from the front side of the front lens body 20.

As illustrated in FIG. 19A, the rear lens unit 41 includes a first entry surface 41a, and a first exit surface 41b on the side opposite to the first entry surface 41a. The rear lens unit 41 is mainly responsible for condensing the light from the light sources 42a to 42c passing through the rear lens unit 41 in the first direction.

The first entry surface 41a is a surface through which the light coming from the light sources 42a to 42c enters the rear lens unit 41. The lateral section of the first entry surface 41a, illustrated in FIG. 17, is configured basically as a curved surface that is convex in the backward direction, but the shape of each lateral section is not the same, and the cross-sectional shape of the lateral section is different in each lateral section. The longitudinal section of the first entry surface 41a, illustrated in FIG. 19A, is configured basically as a curved surface that is convex in the forward direction, but the shape of each longitudinal section is not the same, and the cross-sectional shape of the longitudinal section is different in each longitudinal section. A concrete surface shape of the first entry surface 41a will be described later.

The first exit surface 41b is a surface through which the respective light coming from the light sources 42a to 42c, which entered the rear lens unit 41 through the first entry surface 41a, exits. The first exit surface 41b is configured as a curved surface convex toward the front. The curvature of the longitudinal cross section and the curvature of the cross section of the first exit surface 41b are, for example, the same in each longitudinal cross section and each cross section.

In the vehicular lamp fitting 10B having the above-described configuration, when the light sources 42a to 42c are turned on, the light from the light sources 42a to 42c enters the rear lens units 41 from the first entry surface 41a and exits from the first exit surface 41b. At this time, the first exit surface 41b (lateral section of the first exit surface 41b) acts to condense, in the first direction, the light from the light source 42a to 42c which exits the first exit surface 41b. Then, the light from the light source 42a to 42c which has exited the first exit surface 41b passes through a space S2 between the rear lens unit 41 and the front lens body 20, further enters the front lens body 20 from the second entry surface 21 and is irradiated forward after exiting the second exit surface 22. At this time, the second exit surface 22 acts to condense, in the second direction, the light from the light source 42a to 42c which exit the second exit surface 22. Thereby, the ADB light distribution pattern is formed.

In other words, the light source images of the light sources 42a to 42c are inverted and projected forward by the rear lens unit 41 and the front lens body 20, which function as the projection lens. Thereby the ADB light distribution pattern is formed.

Next an ADB light distribution pattern, that is formed when the front lens body 20 is disposed in an attitude that is inclined at a predetermined upward angle θ2, as illustrated in FIG. 18, will be described.

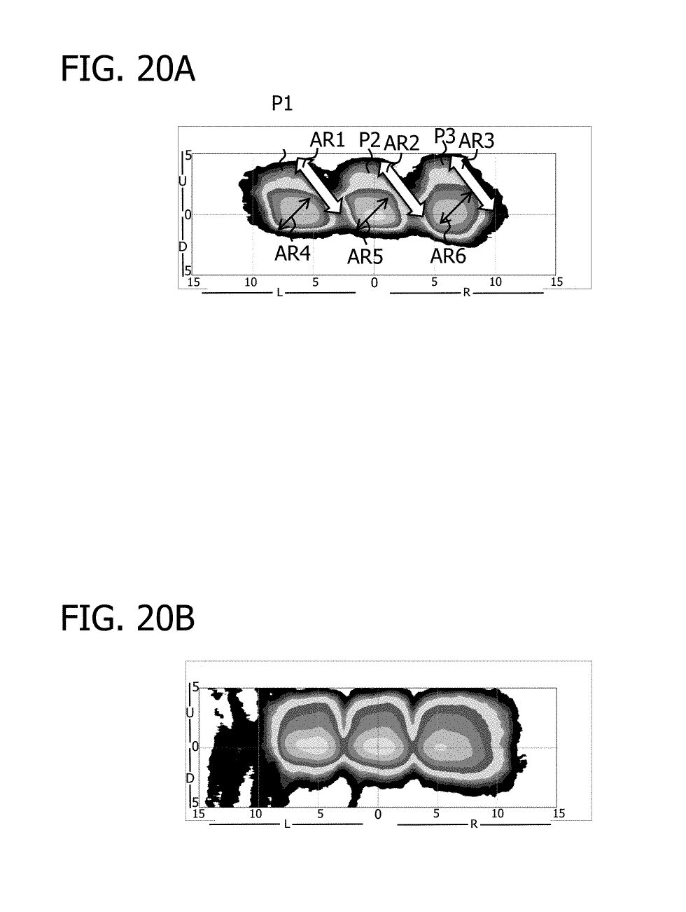

FIG. 20A indicates an example of the ADB light distribution pattern that is formed on a virtual vertical screen facing the front surface of the vehicle (disposed at 25 m in the forward direction from the front surface of the vehicle), when the front lens body 20 is disposed in an attitude that is inclined at a predetermined upward angle θ2.

As illustrated in FIG. 20A, the ADB light distribution pattern includes a plurality of irradiation regions P1 to P3 which are horizontally disposed on a line in the high beam region. The irradiation regions P1 to P3 are independently turned ON/OFF (including lighting in the dimmed state) in accordance with the turning ON/OFF of the light sources 42a to 42c (including lighting in the dimmed state). FIG. 20A indicates an example of the ADB light distribution pattern which is formed in the state that the light sources 42a to 42c are lit (fully lit) respectively.

The present inventors performed simulation and confirmed that the ADB light distribution pattern is stretched in the arrow marks AR1 to AR3 directions, and is formed in a state of being diagonally deformed (diagonal blur state), when the front lens body 20 is disposed in an attitude that is inclined by the upward angle θ2, as illustrated in FIG. 20A.

This is because in the case of disposing the front lens body 20 in an attitude that is inclined by the upward angle θ2, the extending direction, of a focal line FL1 of the projection lens constituted by the front lens body 20 and the rear lens unit 41, becomes a first direction when viewed from the front, as illustrated in FIG. 18, which does not match with the direction in which the light sources 42a to 42c are disposed (horizontal direction).

In other words, in the case of disposing the front lens body 20 in an attitude that is inclined by the upward angle θ2, the extending direction of the focal line FL1 does not match with the direction in which the light sources 42a to 42c are disposed (horizontal direction), therefore the light source images of the light sources 42a to 42c are condensed in the normal direction of the first direction by the front lens body 20 (see FIG. 18), and the light in each of the irradiation regions P1 to P3 is condensed in the arrow marks AR4 to AR6 directions in FIG. 20A respectively. As a result, the ADB light distribution pattern is stretched in the arrow marks AR1 to AR3 directions, and is formed in a state of being diagonally deformed (diagonal blur state).

The focal line FL1 (the same applies to the below-mentioned focal lines FL2 and FL3.) is a group of condensed points which are formed behind the rear lens unit 41, when a plurality of horizontal rays, which are included in a plurality of vertical surfaces having mutually different inclination angles with respect to the optical axis AX_{ADB} respectively, passes through the front lens body 20 and the rear lens unit 41 from the front side of the front lens body 20.

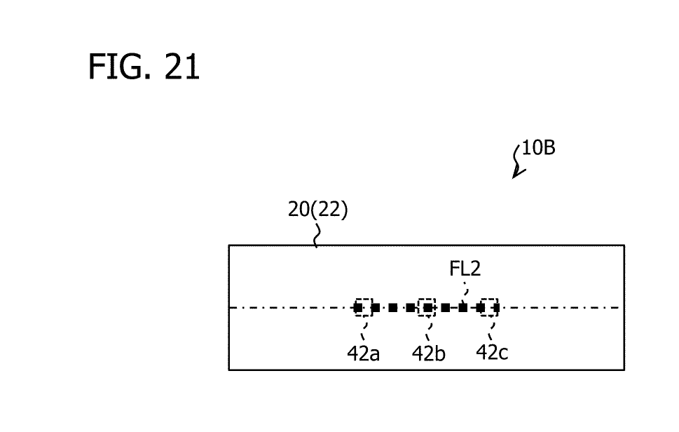

Next an ADB light distribution pattern that is formed when the front lens body 20 is disposed in an attitude that is not inclined by the upward angle θ2, as illustrated in FIG. 21, will be described. FIG. 21 is a front view of the vehicular lamp fitting 10B (when the front lens body 20 is disposed in an attitude that is not inclined by the upward angle θ2).

FIG. 20B is an example of the ADB light distribution pattern which is formed when the front lens body 20 is disposed in an attitude that is not inclined by the upward angle θ2. FIG. 20B indicates an example of the ADB light distribution pattern which is formed on a virtual vertical screen facing the front surface of the vehicle.

In the case of disposing the front lens body 20 in an attitude that is not inclined by the upward angle θ2, the ADB light distribution pattern is not formed in the state of being diagonally deformed (diagonal blur state), but is appropriately formed in the state where the light source images of the light sources 42a to 42c are inversely projected, as illustrated in FIG. 20B, just like the case of using a common projection lens.

This is because in the case of disposing the front lens body 20 in an attitude that is not inclined by the upward angle θ2, the extending direction of a focal line FL2 of the projection lens constituted by the front lens body 20 and the rear lens unit 41, matches with the direction in which the light sources 42a to 42c are disposed (horizontal direction) when viewed from the front, as illustrated in FIG. 21.

As illustrated in FIG. 20A, a configuration for suppressing that the ADB light distribution pattern is formed in a state of being diagonally deformed (diagonal blur state) will be described next.

As a result of intensive studies to suppress formation of the ADB light distribution pattern in an obliquely deformed state, the present inventors discovered that the formation of the ADB light distribution pattern in an obliquely deformed state can be suppressed by adjusting the curvature of the first entry surface 41a in the longitudinal section for each longitudinal section.

This adjustment is an adjustment for correcting the focal lines FL1 shown in FIG. 18 into focal lines (e.g. focal lines FL2 shown in FIG. 21) extending in the horizontal direction (the vehicle width direction). This adjustment is performed using a predetermined simulation software.

An example of adjusting the surface shape of the first entry surface 41a will be described next with reference to FIG. 17.

In FIG. 1, the cross-sectional shape of the first entry surface 41a in the A-A cross-section is adjusted (set) so that when the horizontal ray group included in the A-A cross-section passes through the front lens body 20 and the rear lens unit 41, the horizontal ray group is condensed and forms a condensed point behind the rear lens unit 41 and in the vicinity of a reference axis AX2 (see FIG. 17 and FIG. 18) when viewed from the front. As illustrated in FIG. 17, the reference axis AX2 is a horizontal line orthogonal to the optical axis AX_{ADB}, and passes through the focal point F_{ADB}.

In the same manner, each cross-sectional shape (not shown) of a plurality of longitudinal sections (a plurality of longitudinal sections having mutually different inclination angles with respect to the optical axis AX_{ADB}) between the A-A cross-section and the B-B cross-section as well, is adjusted (set) so that when the horizontal ray group included in each of the plurality of longitudinal sections passes through the front lens body 20 and the rear lens unit 41, the horizontal ray group is condensed and forms a condensed point behind the rear lens unit 41 and in the vicinity of the reference axis AX2 (see FIG. 18) when viewed from the front.

In FIG. 17, the cross-sectional shape of the first entry surface 41a in the B-B cross-section is adjusted (set) so that when the horizontal ray group included in the B-B cross-section passes through the front lens body 20 and the rear lens unit 41, the horizontal ray group is condensed and forms a condensed point behind the rear lens unit 41 and in the vicinity of a reference axis AX2 (see FIG. 18) when viewed from the front.

In FIG. 17, the cross-sectional shape of the first entry surface 41a in the C-C cross-section is adjusted (set) so that when the horizontal ray group included in the C-C cross-section passes through the front lens body 20 and the rear lens unit 41, the horizontal ray group is condensed and forms a condensed point behind the rear lens unit 41 and in the vicinity of a reference axis AX2 (see FIG. 18) when viewed from the front.

In the same manner, each cross-sectional shape (not shown) of a plurality of longitudinal sections (a plurality of longitudinal sections having mutually different inclination angles with respect to the optical axis AX_{ADB}) between the B-B cross-section and the C-C cross-section as well, is adjusted (set) so that when the horizontal ray group included in each of the plurality of longitudinal sections passes through the front lens body 20 and the rear lens unit 41, the horizontal ray group is condensed and forms a condensed point behind the rear lens unit 41 and in the vicinity of the reference axis AX2 (see FIG. 18) when viewed from the front.

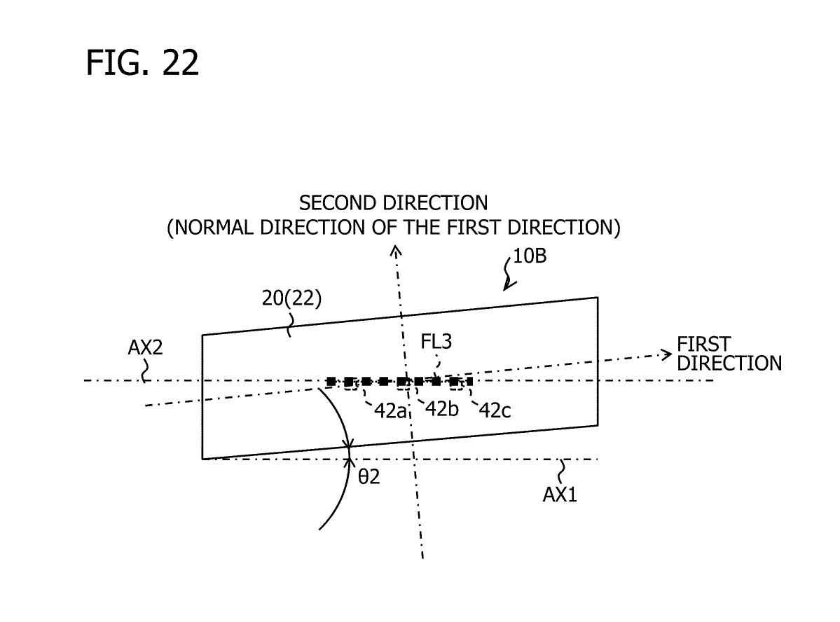

By adjusting the surface shape of the first entry surface 41a as described above, the condensed point group that is formed as above constitutes a focal line F3 which extends in a direction matching (or approximately matching) with the direction in which the light sources 42a to 42c are disposed (horizontal direction) when viewed from the front, even if the front lens body 20 is disposed in an attitude that is inclined by the upward angle θ2, as illustrated in FIG. 22. FIG. 22 is a front view of the vehicular lamp fitting 10B.

In other words, by adjusting the surface shape of the first entry surface 41a as above, the positional relationship between the focal line FL3 and the light sources 42a to 42c when viewed from the front becomes the same as the positional relationship between the focal line FL2 and the light sources 42a to 42c when viewed from the front, as illustrated in FIG. 21.

As a result, the ADB light distribution pattern is not formed in a state of being diagonally deformed (diagonal blur state) even if the front lens body 20 is disposed in an attitude that is inclined by the upward angle θ2, and the ADB light distribution pattern is appropriately formed in the state where the light source images of the light sources 42a to 42c are inversely projected, just like the case of FIG. 20B. In other words, the generation of the ADB light distribution pattern in the state of being diagonally deformed is suppressed.

The first entry surface 41a (surface shape), which is formed by adjusting the surface shape of the first entry surface 41a as above, will be described next.

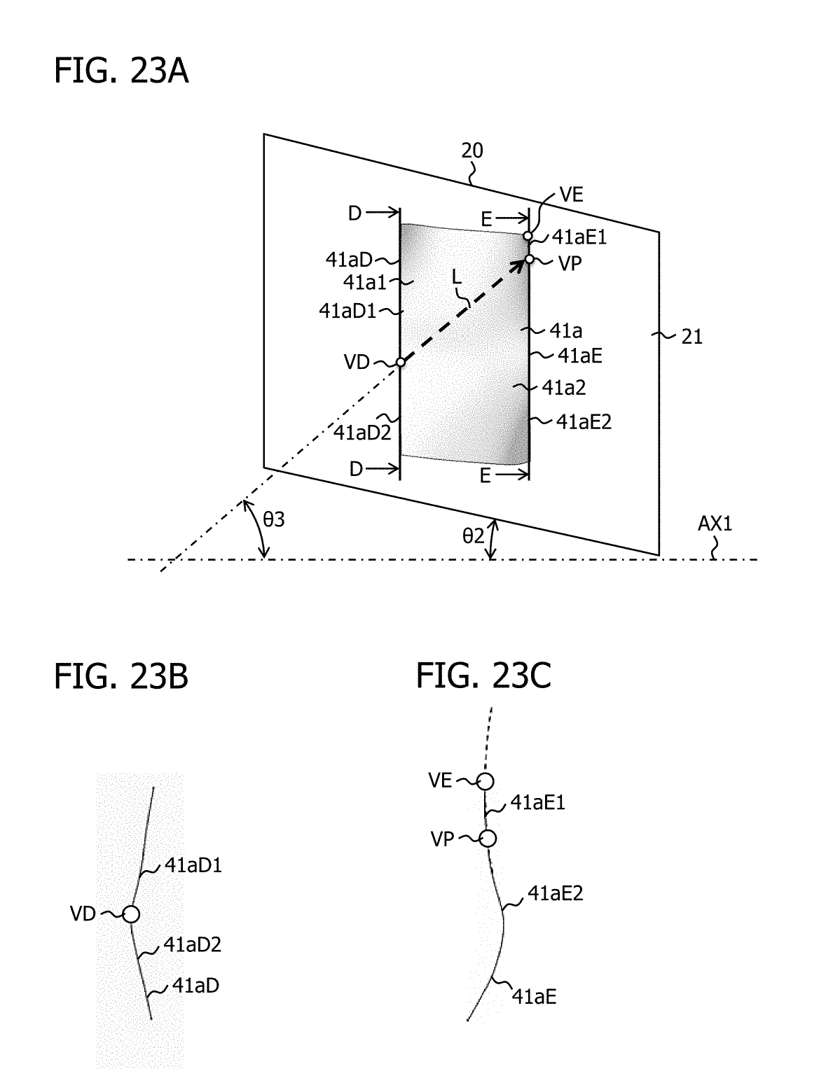

FIG. 23A is a rear view of the rear lens unit 41 (front view of the first entry surface 41a). FIG. 23B is a D-D sectional view of the first entry surface 41a in FIG. 7A, and FIG. 23C is an E-E sectional view of the first entry surface 41a in FIG. 23A.

The longitudinal section of the first entry surface 41a includes a first longitudinal section and a second longitudinal section which is distant from the first longitudinal section in the horizontal direction (vehicle width direction) by a predetermined distance.

The first longitudinal section is a D-D cross-section of the first entry surface 41a, as illustrated in FIG. 23B, and includes a first curve 41aD constituted by: a first vertex VD; a first partial curve 41aD1 which extends linearly from the first vertex VD diagonally upward in the backward direction; and a second partial curve 41aD2 which extends linearly from the first vertex VD diagonally downward in the backward direction.

The second longitudinal section includes, as illustrated in FIG. 23B, a second curve 41aE constituted by: a second vertex VE; an inflection point VP; a third partial curve 41aE1 which extends upward from the inflection point VP, and is slightly convex in the forward direction, and a fourth partial curve 41aE2 which extends downward from the inflection point VP, and is slightly convex in the backward direction.

The first entry surface 41a is a curved surface between the first curve 41aD and the second curve 41aE, that is, a curved surface (e.g. freeform surface) configured such that the surface shape gradually becomes smoother with no step in the direction from the first curve 41aD to the second curve 41aE, and as illustrated in FIG. 7A, the first entry surface 41a includes: a convex portion L which extends linearly between the first vertex VD and the inflection point VP, and is convex in the forward direction; an upper surface 41a1 which is disposed on the upper side of the linearly extending convex portion L; and a lower surface 41a2 which is disposed on the lower side thereof.

The convex portion L extends linearly in a direction that is inclined with respect to the reference axis AX1 at a predetermined angle θ3 in the opposite direction of the upward angle θ2 when viewed from the back (see FIG. 23A).

The upper surface 41a1 is a curved surface between the first partial curve 41aD1 and the third partial curve 41aE1, that is, a curved surface (e.g. freeform surface) configured such that the surface shape gradually becomes smoother with no step in the direction from the first partial curve 41aD1 to the third partial curve 41aE1.

The lower surface 41a2 is a curved surface between the second partial curve 41aD2 and the forth partial curve 41aE2, that is, a curved surface (e.g. freeform surface) configured such that the surface shape gradually becomes smoother with no step in the direction from the second partial curve 41aD2 to the forth partial curve 41aE2.

As described above, according to this embodiment, a vehicular lamp fitting 10B, which suppresses the generation of the ADB light distribution pattern in the state of being diagonally deformed (diagonal blur state), can be provided, even if the front lens body 20 is disposed in an attitude that is inclined at a predetermined upward angle θ2 as shown in FIG. 18.

This is because the surface shape of the first entry surface 41a is adjusted so that the focal line F3 of the projection lens formed by the front lens body 20 and the rear lens unit 41 becomes a focal line extending in the horizontal direction (vehicle width direction) (See FIG. 22).

In concrete terms, the surface shape of the first exit surface 31b is adjusted (set) so that when the horizontal ray group, which is included in each of the plurality of longitudinal sections (vertical surfaces) having mutually different inclination angles with respect to the optical axis AX_{ADB}, passes through the front lens body 20 and the rear lens unit 41, the horizontal ray group is condensed and forms the focal line FL3 (condensed point group) along the reference axis AX2 (along the direction in which the light sources 42a to 42c are disposed) behind the rear lens unit 41 and in the vicinity of the reference axis AX2 (see FIG. 18) when viewed from the front.

A modification will be described next.

In this embodiment, an example of suppressing the generation of the ADB light distribution pattern in the state of being diagonally deformed (diagonal blur state) was described by adjusting the surface shape of the first entry surface 41a, but the present invention is not limited to this.

For example, the generation of the ADB light distribution pattern in the state of being diagonally deformed (diagonal blur state) may be suppressed by adjusting the surface shape of at least one of the first entry surface 41a, the first exit surface 41b and the second entry surface 21. The surface shape of the first exit surface 41b and the surface shape of the second entry surface 21 can also be adjusted in the same manner as the adjustment of the surface shape of the first entry surface 41a.

It goes without saying that the numbers in the above-described embodiment are merely examples and other appropriate numbers may be used.

The various aspects of the above-described embodiment are merely exemplary and the description of the embodiment is not intended to limit the scope of the present invention. The present invention may be implemented in numerous other ways without departing from the gist or main technical characteristics of the present invention.

1. A vehicular lamp fitting comprising: a front lens body; a rear lens unit disposed behind the front lens body; and a light source that is disposed behind the rear lens unit, and that emits light, which passes through the rear lens unit and the front lens body in this order and is irradiated forward, so as to form a low beam light distribution pattern, wherein
the rear lens unit is a lens unit configured to condense, at least in a first direction, the light coming from the light source and passing through the rear lens unit, and includes: a first entry surface through which the light coming from the light source enters the rear lens unit; a first exit surface through which the light coming from the light source, which entered the rear lens unit, exits; and an edge which defines a cut-off line of the low beam light distribution pattern,
the front lens body is a lens unit configured to condense, in a second direction intersecting the first direction, the light coming from the rear lens unit and passing through the front lens body, and includes: a second entry surface through which the light coming from the rear lens unit enters the front lens body; and a second exit surface through which the light coming from the rear lens unit, which entered the front lens body, exits,
the front lens body is disposed in an attitude that is inclined at a predetermined receding angle, and
at least one of a curvature of the first exit surface in the longitudinal section and a curvature of the second entry surface in the longitudinal section is different in each longitudinal section.

2. The vehicular lamp fitting according to claim 1, wherein
the longitudinal section is a cross-section of the first exit surface or a cross-section of the second entry surface through which a horizontal ray group, which is included in each of a plurality of vertical surfaces having mutually different inclination angles, passes when the horizontal ray group, which is included in each of the plurality of vertical surfaces, enters the front lens body through the second exit surface, and
the edge is disposed along a focal line which is formed by condensation of the horizontal ray group, which is included in each of the plurality of vertical surfaces, in the rear lens unit when the horizontal ray group exits through the second entry surface and enters the rear lens unit through the first exit surface.

3. The vehicular lamp fitting according to claim 2, wherein at least one of the curvature of the first exit surface in the longitudinal section and the curvature of the second entry surface in the longitudinal section is adjusted for each longitudinal section so that the focal line becomes a focal line extending in the vehicle width direction.

4. The vehicular lamp fitting according to claim 2, wherein the curvature of the first exit surface in the longitudinal section is adjusted for each longitudinal section so as to be larger as the distance between the second entry surface and the first exit surface, through which the horizontal ray group included in each of the plurality of vertical surfaces passes, is shorter.

5. The vehicular lamp fitting according to claim 2, wherein the curvature of the second entry surface in the longitudinal section is adjusted for each longitudinal section so as to be larger as the distance between the second entry surface and the first exit surface through which the horizontal ray group included in each of the plurality of vertical surfaces passes, is shorter.

6. A vehicular lamp fitting comprising: a front lens body; a rear lens unit disposed behind the front lens body; and a light source that is disposed behind the rear lens unit, and that emits light, which passes through the rear lens unit and the front lens body in this order and is irradiated forward, so as to form a low beam light distribution pattern, wherein
the rear lens unit is a lens unit configured to condense, at least in a first direction, the light coming from the light source and passing through the rear lens unit, and includes: a first entry surface through which the light coming from the light source enters the rear lens unit; a first exit surface through which the light coming from the light source, which entered the rear lens unit, exits; and an edge which defines a cut-off line of the low beam light distribution pattern,
the front lens body is a lens unit configured to condense, in a second direction intersecting the first direction, the light coming from the rear lens unit and passing through the front lens body, and includes: a second entry surface through which the light coming from the rear lens unit enters the front lens body; and a second exit surface through which the light coming from the rear lens unit, which entered the front lens body, exits,
the front lens body is disposed in an attitude that is inclined at a predetermined receding angle,
the surface shape of at least one of the first exit surface and the second entry surface is adjusted so that when a horizontal ray group, which is included in each of a plurality of vertical surfaces having mutually different inclination angles, enters the rear lens unit through the front lens body from the front side of the front lens body, the horizontal ray group is condensed in the rear lens unit so as to form a focal line extending in the vehicle width direction, and
the edge is disposed along the focal line.

7. A vehicular lamp fitting comprising: a front lens body; a rear lens unit disposed behind the front lens body; and a plurality of light sources that are disposed behind the rear lens unit, and that emit light, which passes through the rear lens unit and the front lens body in this order and is irradiated forward so as to form an ADB light distribution pattern, wherein
the rear lens unit is a lens unit configured to condense, at least in a first direction, the light coming from the light sources and passing through the rear lens unit, and includes: a first entry surface through which the light coming from the light sources enters the rear lens unit; and a first exit surface through which the light coming from the light sources, which entered the rear lens unit, exits,
the front lens body is a lens unit configured to condense, in a second direction intersecting the first direction, the light coming from the rear lens unit and passing through the front lens body, and includes: a second entry surface through which the light coming from the rear lens unit enters the front lens body; and a second exit surface through which the light coming from the rear lens unit, which entered the front lens body, exits,
the front lens body is disposed in an attitude that is inclined at a predetermined receding angle, and
at least one of a curvature of the first exit surface in the longitudinal section, a curvature of the first entry surface in the longitudinal section, and a curvature of the second entry surface in the longitudinal section is different in each longitudinal section.

8. The vehicular lamp fitting according to claim 7, wherein
the longitudinal section is a cross-section of the first exit surface, or a cross-section of the first entry surface or the second entry surface through which a horizontal ray group, which is included in each of the plurality of vertical surfaces having mutually different inclination angles, passes when the horizontal ray group, which is included in each of the vertical surfaces, enters the front lens body through the second exit surface, and
the plurality of light sources are disposed along a focal line which is formed by condensation of the horizontal ray group, which is included in each of the plurality of vertical surfaces, behind the rear lens unit when the horizontal ray group passes through the front lens body and the rear lens unit.

9. The vehicular lamp fitting according to claim 8, wherein at least one of the curvature of the first exit surface in the longitudinal section, the curvature of the first entry surface in the longitudinal section, and the curvature of the second entry surface in the longitudinal section is adjusted for each longitudinal section so that the focal line becomes a focal line extending in the vehicle width direction.

10. The vehicular lamp fitting according to claim 8, wherein the curvature of the first exit surface in the longitudinal section is adjusted for each longitudinal section so as to be larger as the distance between the second entry surface and the first exit surface, through which the horizontal ray group included in each of the plurality of vertical surfaces passes, is shorter.

11. The vehicular lamp fitting according to claim 8, wherein the curvature of the first entry surface in the longitudinal section is adjusted for each longitudinal section so as to be larger as the distance between the second entry surface and the first exit surface through which the horizontal ray group included in each of the plurality of vertical surfaces passes, is shorter.

12. The vehicular lamp fitting according to claim 8, wherein the curvature of the second entry surface in the longitudinal section is adjusted for each longitudinal section so as to be larger as the distance between the second entry surface and the first exit surface through which the horizontal ray group included in each of the plurality of vertical surfaces passes, is shorter.

13. A vehicular lamp fitting comprising: a front lens body; a rear lens unit disposed behind the front lens body; and a plurality of light sources that are disposed behind the rear lens unit, and that emit light, which passes through the rear lens unit and the front lens body in this order and is irradiated forward, so as to form an ADB light distribution pattern, wherein
the rear lens unit is a lens unit configured to condense, at least in a first direction, the light coming from the light sources and passing through the rear lens unit, and includes: a first entry surface through which the light coming from the light sources enters the rear lens unit; and a first exit surface through which the light coming from the light sources, which entered the rear lens unit, exits,
the front lens body is a lens unit configured to condense, in a second direction intersecting the first direction, the light coming from the rear lens unit and passing through the front lens body, and includes: a second entry surface through which the light coming from the rear lens unit enters the front lens body; and a second exit surface through which the light coming from the rear lens unit, which entered the front lens body, exits,
the front lens body is disposed in an attitude that is inclined at a predetermined receding angle, and
the surface shape of at least one of the first exit surface, the first entry surface and the second entry surface is adjusted so that when a horizontal ray group, which is included in each of a plurality of vertical surfaces having mutually different inclination angles, enters the rear lens unit through the front lens body from the front side of the front lens body, the horizontal ray group is condensed behind the rear lens unit so as to form a focal line extending in the vehicle width direction, and
the plurality of light sources are disposed along the focal line.

14. A vehicular lamp fitting comprising: a front lens body; a rear lens unit disposed behind the front lens body; and a plurality of light sources that are disposed behind the rear lens unit, and that emit light, which passes through the rear lens unit and the front lens body in this order and is irradiated forward, so as to form an ADB light distribution pattern, wherein
the rear lens unit is a lens unit configured to condense, at least in a first direction, the light coming from the light sources and passing through the rear lens unit, and includes: a first entry surface through which the light coming from the light sources enters the rear lens unit; and a first exit surface through which the light coming from the light sources, which entered the rear lens unit, exits,
the front lens body is a lens unit configured to condense, in a second direction intersecting the first direction, the light coming from the rear lens unit and passing through the front lens body, and includes: a second entry surface through which the light coming from the rear lens unit enters the front lens body; and a second exit surface through which the light coming from the rear lens unit, which entered the front lens body, exits,
the front lens body is disposed in an attitude that is inclined at a predetermined upward angle,
a surface shape of at least one of the first exit surface, the first entry surface, and the second entry surface is adjusted so that a focal line of a projection lens constituted by the front lens body and the rear lens unit is a focal line extending in the horizontal direction, and
the plurality of light sources are disposed along the focal line.

15. The vehicular lamp fitting according to claim 14, wherein
the longitudinal section of the first entry surface includes:
a first longitudinal section including a first curve which has a first vertex, a first partial curve which extends linearly from the first vertex diagonally upward in the backward direction, and a second partial curve which extends linearly from the first vertex diagonally downward in the backward direction; and
a second longitudinal section including a second curve which has a second vertex, an inflection point, a third partial curve which extends upward from the inflection point and is convex in the forward direction, and a fourth partial curve which extends downward from the inflection point and is convex in the backward direction,
the first entry surface is a curved surface configured such that the surface shape gradually changes in a direction from the first curve to the second curve, and includes: a convex portion which extends linearly between the first vertex and the inflection point, and is convex in the forward direction; an upper surface which is disposed on the upper side of the linearly extending convex portion; and a lower surface which is disposed on the lower side of the convex portion, and
the convex portion extends linearly in a direction which is inclined with respect to the reference axis at a predetermined angle in the opposite direction of the predetermined upward angle when viewed from the back.

16. The vehicular lamp fitting according to claim 15, wherein
the upper surface is a curved surface configured such that the surface shape gradually changes in a direction from the first partial curve to the third partial curve, and
the lower surface is a curved surface configured such that the surface shape gradually changes in a direction from the second partial curve to the fourth partial curve.
